(19) United States
(12) Patent Application Publication
(10) Pub. No.: US 2025/0206918 A1
(43) Pub. Date: Jun. 26, 2025

(54) COMPOSITIONS AND METHODS FOR THE FABRICATION OF SUPRAMOLECULAR MATERIALS WITH NANOSTRUCTURES AND SPATIALLY DISTINCT FEATURES

(71) Applicant: The University of Hong Kong, Hong Kong (CN)

(72) Inventors: Vivian Wing-Wah Yam, Hong Kong (CN); Zhen Geng, Hong Kong (CN); Lok-Yi Chiu, Hong Kong (CN); Ki Ip, Hong Kong (CN)

(21) Appl. No.: 18/972,184

(22) Filed: Dec. 6, 2024

Related U.S. Application Data
(60) Provisional application No. 63/613,944, filed on Dec. 22, 2023.

(51) Int. Cl. C08K 5/56; B82Y 40/00; C07F 15/00

(52) U.S. Cl. CPC C08K 5/56; B82Y 40/00; C07F 15/006; C07F 15/0086

(57) ABSTRACT

Supramolecular nanostructures having spatially distinct features and methods for the preparation of such nanostructures are disclosed. The supramolecular nanostructures are composed of planar, or linear small molecules associated with each other through non-covalent interactions including, but not limited to, metal-metal interactions, π-π interactions, hydrogen bonding interactions, solvophobic-solvophobic interactions, or a combination thereof, and polymer components stabilized by non-covalent interactions. These supramolecular nanostructure materials can exhibit a wide variety of functional properties due to the two chemically diverse components, in which a great flexibility and a large variety of choices are available, enabling options to control the supramolecular nanostructure's luminescence properties and compositions.

### CROSS-REFERENCE TO RELATED APPLICATION

This application claims the benefit of and priority to U.S. Provisional Application No. 63/613,944 filed Dec. 22, 2023, which is incorporated herein by reference in its entirety.

### FIELD OF THE INVENTION

The invention is generally in the field of materials (preferably soft materials which are assembled by dynamic supramolecular interactions and responsive to changes in their environment) and supramolecular self-assembly, and specifically in the area of assembly of multi-component systems containing planar small molecules and block copolymers into supramolecular nanostructures that exhibit spatially distinct features.

### BACKGROUND OF THE INVENTION

Development of methods that can make molecular, macromolecular and nanostructured assemblies with controlled dimensions, ordered structures and complexity through non-covalent interactions is a major theme of supramolecular chemistry and nanotechnology. Supramolecular self-assembly, which has its roots in biology, is one route to connect building blocks with one another through non-covalent interactions and plays a vital role in the construction of natural materials with various fascinating properties and functions. The building blocks can be molecules, macromolecules, or nanoparticles. The supramolecular nanostructures formed can be coiled chains connected by non-covalent interactions, nanofibers of peptide amphiphiles, worm-like micelles of block copolymers, or one-dimensional nanostructured assemblies (Lehn J M, et al., Angew. Chem. Int. Ed. 27, 89 (1988); Fouquey C, et al., Adv. Mater. 2, 254 (1990); Brunsveld L, et al., Chem. Rev., 101, 4071 (2001); De Greef TFA, et al., Chem. Rev. 109, 5687 (2009); Aida T, et al., Science 335, 813 (2012); Fox J D, et al., Macromolecules, 42, 6823 (2009); Fiore G L, et al., Chem. Soc. Rev., 42, 7278 (2013); Yang L L, et al., Chem. Rev., 115, 7196 (2015)).

One type of supramolecular self-assembly is living supramolecular polymerization, which is a supramolecular counterpart of covalent bond-based polymerization. During the living supramolecular polymerization processes, the termini of the propagating supramolecular nanostructures are active; and after supramolecular polymerization, the ends of the supramolecular nanostructures formed remain active. Addition of extra monomers resumes the supramolecular polymerization to produce a longer supramolecular polymer. Therefore, through a typical seeded growth procedure, living supramolecular polymerization allows for the preparation of sequence-controllable integrated architectures with well-defined dimensions and compositions as well as spatially distinct features.

For instance, Manners and coworkers have developed crystallization-driven self-assembly (CDSA) of block copolymers containing a crystallizable block of polyferrocenyldimethylsilane (PFS) (Wang X, et al., Science, 317, 644 (2007)). In a selective solvent, the PFS-containing block copolymers are described to form cylindrical micelles with PFS cores through a heating-cooling process. Addition of unimers of PFS-containing block copolymers is said to lead to the epitaxial growth of the cylindrical micelles at both ends. In contrast, addition of unimers of PFS-containing block copolymers into selected pure solvents is said to only lead to the formation of irregular amorphous aggregates. With CDSA, cylindrical micelles with controlled lengths and narrow length distributions are obtained, and cylindrical block co-micelles with certain block lengths and defined architectures are prepared (Gilroy J B, et al., Nat. Chem., 2, 566 (2010); Gadt T, et al., Nat. Mater., 8, 144 (2009); Qiu H, et al., Science, 347, 1329 (2005)). In CDSA, only a single-component system is involved in the formation of the cylindrical micelles and the formation of each block of the cylindrical block co-micelles.

In another instance, Aida and coworkers have studied chain-growth supramolecular polymerization of a specific monomer and a specific initiator, both carrying a similar chemical structure of a corannulene core with five amide-appended thioalkyl side chains (Kang J, et al., Science, 347, 646 (2015)). The monomers are metastable, adopting a cage-like closed conformation that is conformationally restricted from spontaneous polymerization at room temperature. The initiator is said to interact with the monomer via multiple hydrogen bonding to open the closed conformation of the monomer and start the chain-growth supramolecular polymerization. Although this living supramolecular polymerization process involves two components (the initiator and the monomer), the two components possess very similar chemical structures.

To date, living supramolecular polymerization based on self-assembly of two components with dissimilar structures has been rarely reported and methods of living supramolecular polymerization are limited to a few examples. In these reported methods, the living supramolecular polymerizations are based on single-component systems or two-component systems of initiator and monomer with very similar structures. The works by Manners, Takeuchi, and Aida are greatly dependent on the chemical structures and configurations of certain specific molecules or macromolecules to realize living supramolecular polymerization. It is noteworthy that the building blocks for these living supramolecular polymerization systems are always single-component with similar molecular structures; meanwhile, the supramolecular polymerization of different kinds of single-component subunits obeys similar association mechanism and cooperatively couple with the other subunit rather than self-sorted. Therefore, the integrated segments on the heteroarchitectures possess exactly the same or similar inherent internal order owing to the similar molecular structure of the subunits as well as the same association mechanism driven by synergistic directional noncovalent interactions.

In addition to the supramolecular heteroarchitectures with spatially distinct chemical compositions and similar inherent internal order, there are other important classes of supramolecular heteroarchitectures (named as topological heterostructures) which are composed of different domains with distinct physical properties (i.e., stiffness, packing density, topologies, etc.). Construction of such topological heterostructures would be of particular significance not only in fundamental supramolecular chemistry to unravel the complex interplays among structural dissimilar subunits, but also in materials science by using them as unique nanomaterials to function like biomacromolecules. Moreover, the topological heterostructures may contain heterojunctions between the topologically different segments, and thus endow them with uncommon optical, charge transport, and catalytic properties for directional excitation energy, as well as electron and hole transport.

Yagai and co-workers have reported examples of topological block fibers containing helically folded domains from kinetically controlled gradient supramolecular copolymerization of two molecules with similar chemical structures but affording supramolecular polymers with distinct topologies (Tashiro, K. et al., Angew. Chem. Int. Ed. 60, 26986 (2021)). Furthermore, they prepared a photo-responsive helically folded supramolecular polymers from a barbiturate monomer to achieve non-uniform unfolding by UV-light irradiation, and thus realizing the formation of topological block fibers containing folded and unfolded domains. Nevertheless, except for limited examples using elaborately designed molecular subunits, bottom-up synthesis of such topological heterostructrues remains a formidable challenge since the building blocks with different molecular structures are difficult to cooperatively connect through non-covalent interactions (heterorecognition).

Alternatively, d8 and d10 metal complexes have been studied for self-assembly behaviors (Yam V W W, et al., Chem. Rev., 115, 7589 (2015)). For example, platinum(II) polypyridine complexes have been reported to exhibit intriguing spectroscopic and luminescence properties and a propensity to form highly ordered extended linear chains or oligomeric structures in the solid state based on non-covalent metal-metal and π-π interactions (Miskowski V M, et al., Inorg. Chem., 28, 1529 (1989); Miskowski V M, et al., Inorg. Chem., 30, 4446 (1991); Houlding V H, et al., Coord. Chem. Rev., 111, 145 (1991); Bailey J A, et al., Inorg. Chem., 34, 4591 (1995); Yip H K, et al., J. Chem. Soc. Dalton Trans., 2933 (1993); Wong K M C, et al., et al., Acc. Chem. Res., 44, 424 (2011)). With introduction of alkynyl ligand in place of chloro ligand, alkynylplatinum(II) terpyridine complexes were found to be more soluble and aggregation through non-covalent metal-metal and π-π interactions was observed upon addition of non-solvents (Yam V W W, et al., J. Am. Chem. Soc., 124, 6506 (2002)). Polyelectrolytes are studied for inducing aggregation and self-assembly of oppositely charged platinum(II) complexes in a solution state, giving rise to drastic spectroscopic changes (Yu C, et al., Angew. Chem. Int. Ed., 117, 801 (2005); Yu C, et al., Proc. Natl. Acad. Sci. USA, 103, 19652 (2006); Chung C Y S, et al., J. Am. Chem. Soc., 133, 18775 (2011); Chung C Y S, et al., Chem. Commun., 47, 2000 (2011)). In these polyelectrolyte-platinum(II) complex systems, both the electrostatic attractions between polyelectrolytes and platinum(II) complexes and the metal-metal interactions are responsible for the assembly and aggregation of the platinum(II) complexes.

In particular, supramolecular co-assembly of two structurally dissimilar components, that is, cationic platinum(II) complexes and negatively charged polyelectrolyte-containing block copolymers is a promising and versatile strategy to create crystalline nanostructures of a wide variety of well-defined sizes, shapes, and compositions (Zhang K, et al., Chem, 2, 825 (2017); Zhang K, et al., J. Am. Chem. Soc., 140, 9594 (2018); Zhang K, et al., ACS Appl. Mater. Interfaces, 12, 8503 (2020)). More importantly, living supramolecular polymerization could be achieved by such kind of two-component co-assembly systems, producing one-dimensional segmented nanostructures containing heterojunctions with a large lattice mismatch (Zhang K, et al., Proc. Natl. Acad. Sci. USA, 114, 11844 (2017)). In such systems, co-assembly of platinum(II) complexes and block copolymers in aqueous medium led to the immediate formation of nanoaggregates, which could be regarded as the seed or nucleus for living supramolecular polymerization. The packing density and composition of the co-assembled structures are strongly dependent on both the type of complex unimers and the relative block length of the block copolymers, which would render the construction of one-dimensional heterostructures with segmented growth of distinct stiffness and packing lattices possible through the use of different building blocks in the sequential seeded growth procedures. However, this method has been limited to the creation of di- or tri-block one-dimensional heterostructures, probably due to constraints in the further extension of the dimensionality and topology for its epitaxial growth from the termini of the flexible segments.

To overcome this limitation, a strategy to orchestrate the co-assembly processes for the two-component systems in an optimal manner is needed. Given that organometallic complexes themselves could afford well-defined crystalline structures from a bottom-up supramolecular polymerization approach driven by the directional noncovalent interactions, one can envision that by utilizing the crystalline supramolecular polymers of complexes instead of their monomers to interact with polyelectrolyte-containing block copolymers, the co-assembly processes would preferentially occur in situ, resulting in reconfigured nanostructures containing distinct components with high-order structural regulation beyond their original shape and dimensionality. Recent works by us have demonstrated the interplay of different extents of metal-metal interactions and hydrophobic interactions in controlling highly crystalline and ordered one-dimensional nanostructures versus amorphous and less ordered flexible nanostructures (Zheng X. et al., Proc. Natl. Acad. Sci. USA, 119, e2116543119 (2022)), which has led to the potential use of these assemblies of square-planar d8 metal complexes that are held together by multiple noncovalent interactions to serve as ideal building blocks for directing diverse dimensionality and topologies through co-assembly.

It is therefore an object of the present invention to provide supramolecular nanostructures with diverse compositions, intriguing properties, controlled dimensions and different architectures through two-component supramolecular co-assembly, and their applications in various fields.

It is another object of the present invention to provide a process of supramolecular co-assembly based on two-component self-assembly of small molecules and polymers for rational fabrication of sophisticated architectures with adjacent segments possessing distinct physical and chemical properties, including composition, packing density, topologies, etc.

### SUMMARY OF THE INVENTION

Disclosed herein is a method for the preparation of a series of supramolecular nanostructures having spatially distinctive compositions and/or stiffness (supramolecular heterostructures containing rigid and flexible segments with different compositions or flexible supramolecular co-micelles with segmented architectures). The supramolecular nanostructure contains non-covalently associated (e.g., assembled) planar or linear small molecules, based on metal-metal interactions, π-π interactions, hydrogen-bonding interactions, solvophobic-solvophobic interactions, or a combination thereof, which are further stabilized by a polymer via a non-covalent interaction including electrostatic attractions with the planar or linear small molecules. The disclosed supramolecular nanostructures can have a nano- and/or micro-structure such as nanofibers, nano-belts, nano-ribbons, and nano-loops whose widths and thicknesses are in the nanometer range with a length from nanometers to microns or even millimeters. The disclosed supramolecular nanostructure contains spatially distinct compositions. Each segment is composed of the same or different planar or linear small molecules or metal complex molecules and the same or different polymers. The disclosed supramolecular nanostructure can contain rigid segments composed of planar or linear small molecules or metal complex molecules and their flexible segments composed of the same planar or linear small molecules or metal complex molecules and polymers. The disclosed supramolecular nanostructure can contain alternate segments with controllable length, composition, and dimensions. Therefore, the disclosed method for preparation of supramolecular nanostructures can be made up of supramolecular heterostructures with controlled dimensions and various compositions containing different types of heterojunctions or a flexible supramolecular block co-micelles with controlled compositions and dimensions.

A two-step process for supramolecular co-assembly of supramolecular polymers/copolymers formed from planar or linear small molecules or metal complex molecules and polymers in solution is also provided. In the first step, supramolecular polymers are prepared from a solvophobic small-molecule component with planar or linear geometry. In some cases, supramolecular copolymers are prepared through seeded growth of at least two kinds of small-molecule components with similar ligand structure but different metal centers. The supramolecular polymers/copolymers are used as precursors. In the second step, solvophilic polymers are added to the solution of preformed precursors to induce the supramolecular co-assembly. Solvent is selected such that the small-molecule component with planar or linear geometry is solvophobic and exhibits a strong tendency to undergo supramolecular polymerization of the small-molecule components. Meanwhile, the preformed supramolecular polymers/copolymers can co-assemble in the presence of the solvophilic polymer component. In an aqueous medium, the planar or linear small molecule is hydrophobic, while the polymer component is hydrophilic or amphiphilic and soluble in water. Non-covalent metal-metal interactions, π-π interactions, hydrogen-bonding interactions, solvophobic-solvophobic (or hydrophobic-hydrophobic) interactions, or a combination of various interactions between the planar or linear small molecules or metal complex molecules direct the growth of supramolecular polymers; and the polymer component interacts with the planar or linear small molecules or metal complex molecules non-covalently at different regions of the supramolecular polymers/copolymers to form the supramolecular co-assembled nanostructures.

The disclosed process can be used to prepare supramolecular nanostructures with spatially distinct features. The disclosed supramolecular nanostructures are composed of different segments with various compositions, dimensions and architectures. The supramolecular nanostructures formed exhibit rich spectroscopic and luminescence properties as well as other functional properties. In some forms, the supramolecular nanostructures show more intense absorption in the visible region and much stronger emission in the near-infrared region, compared to the monomeric small-molecule metal complexes, e.g., platinum(II) complexes.

Unlike the existing techniques which rely on single-component systems, the disclosed process using at least two chemically diverse components, in which a great flexibility and a large variety of choices of planar small molecules as the building blocks for the formation of supramolecular nanostructures are available. The small-molecule component and the polymer component can be designed and synthesized independently. Many metal complexes with square-planar, trigonal-planar and linear geometries as well as planar organic molecules, which show strong tendency to associate with each other through non-covalent metal-metal interactions, π-π interactions, hydrogen-bonding interactions, solvophobic-solvophobic (or hydrophobic-hydrophobic) interactions, or a combination of different interactions, can be used to prepare the preformed precursors of supramolecular polymers/copolymers.

The process allows facile control of the lengths of different segments in the supramolecular nanostructures by changing the feed ratios of the polymer components to the small-molecule components or the concentration of the preformed supramolecular polymers/copolymers. The lengths of the segments on flexible supramolecular block co-micelles are dependent on the relative length of segments on the preformed supramolecular copolymers.

The process also allows facile control of the number of segments in the supramolecular nanostructures by changing the type of the small-molecule components chosen for the precursor preparation or the feed ratios of the polymer components to the small-molecule components. The number of segments in the supramolecular nanostructures can also be increased by inducing hierarchical self-assembly of preformed supramolecular heterostructures. The number of segments on the flexible supramolecular block co-micelles are dependent on the number of segments on the preformed supramolecular copolymers.

The disclosed supramolecular heterostructures can have neighboring segments connected with each other via heterojunctions upon co-assembly with the polymer component. The connecting topology of the heterojunctions can be controlled by the relative block length of the polymer components or the rate of addition of the polymer components during the co-assembly.

The disclosed supramolecular heterostructures in the solution state exhibit selective spatial co-assembly properties upon introduction of guest molecules. The flexible segments on the heterostructures can undergo co-assembly with small molecules or nanoparticles decorated with oppositely charged moieties, enabling options to control their luminescence properties and compositions.

Additional advantages of the disclosed method and compositions will be set forth in part in the description which follows, and in part will be understood from the description, or may be learned by practice of the disclosed method and compositions. The advantages of the disclosed method and compositions will be realized and attained by means of the elements and combinations particularly pointed out in the appended claims. It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several embodiments of the disclosed method and compositions and together with the description, serve to explain the principles of the disclosed method and compositions.

FIGS. 1 and 2 show the UV-vis absorption spectra (FIG. 1) and the steady-state emission spectra (FIG. 2, λₑₓ=415 nm) of supramolecular polymers of complex 1 (0.10 mM) in aqueous solution and tri-block heterostructures formed from co-assembly of supramolecular polymers of complex 1 (0.40 mM)+PEG₄₅-b-PAA₄₃ ([carboxylic acid]=1.0 mM) in aqueous solution, respectively. The solution of supramolecular polymers and co-assemblies were diluted to reach a predominant concentration of complex 1 of 0.1 mM before measurements. (Entry no. 1 in Table 1: Complex 1 is shown in Formula 2 and the anion, X⁻, is hexafluorophosphate PF₆⁻).

FIGS. 3 and 4 show the UV-vis absorption spectra (FIG. 3) and the steady-state emission spectra (FIG. 4, λₑₓ=515 nm) of supramolecular polymers of complex 2 (0.15 mM) in aqueous solution and penta-block heterostructures formed from co-assembly of supramolecular polymers of complex 2 (0.15 mM)+PEG₄₅-b-PAA₅₀ ([carboxylic acid]=0.6 mM) in aqueous solution, respectively. The solution of supramolecular polymers and co-assemblies were diluted to reach a predominant concentration of complex 2 of 0.1 mM before measurements. (Entry no. 11 in Table 1: Complex 2 is shown in Formula 4 and the anion, X⁻, is PF₆⁻).

FIGS. 5 and 6 show the UV-vis absorption spectra (FIG. 5) and the steady-state emission spectra (FIG. 6, λₑₓ=430 nm) of supramolecular polymers of complex 4 (0.15 mM) in aqueous solution and penta-block heterostructures formed from co-assembly of supramolecular polymers of complex 4 (0.15 mM)+PEG₄₅-b-PAA₅₀ ([carboxylic acid]=0.6 mM) in aqueous solution, respectively. The solution of supramolecular polymers and co-assemblies were diluted to reach a predominant concentration of complex 4 of 0.1 mM before measurements. (Entry no. 12 in Table 1: Complex 4 is shown in Formula 8 and the anion, X⁻, is PF₆⁻).

FIGS. 7 and 8 show the UV-vis absorption spectra (FIG. 7) and the steady-state emission spectra (FIG. 8, λₑₓ=522 nm) of supramolecular polymers of complex 3 (0.15 mM) in aqueous solution and penta-block heterostructures formed from co-assembly of supramolecular polymers of complex 3 (0.15 mM)+PEG₄₅-b-PAA₅₀ ([carboxylic acid]=0.6 mM) in aqueous solution, respectively. The solution of supramolecular polymers and co-assemblies were diluted to reach a predominant concentration of complex 3 of 0.1 mM before measurements. (Entry no. 13 in Table 1: Complex 3 is shown in Formula 6 and the anion, X⁻, is PF₆⁻).

FIG. 9 shows the scanning electron microscopic (SEM) image of tri-block heterostructures formed from co-assembly of supramolecular polymers of complex 1 (0.40 mM)+PEG₄₅-b-PAA₄₃ ([carboxylic acid]=1.0 mM) in aqueous solution, respectively. (Entry no. 1 in Table 1: Complex 1 is shown in Formula 2 and the anion, X⁻, is PF₆⁻).

FIG. 10 shows the SEM image of penta-block heterostructures formed from co-assembly of supramolecular polymers of complex 1 (0.20 mM)+PEG₄₅-b-PAA₄₃ ([carboxylic acid]=0.50 mM) in aqueous solution, respectively. (Entry no. 2 in Table 1: Complex 1 is shown in Formula 2 and the anion, X⁻, is PF₆⁻).

FIG. 11 shows the SEM image of penta-block heterostructures formed from co-assembly of supramolecular polymers of complex 1 (0.20 mM)+PEG₄₅-b-PAA₄₃ ([carboxylic acid]=1.0 mM) in aqueous solution, respectively. (Entry no. 3 in Table 1: Complex 1 is shown in Formula 2 and the anion, X⁻, is PF₆⁻).

FIG. 12 shows the SEM image of loops formed from co-assembly of supramolecular polymers of complex 1 (0.10 mM)+PEG₄₅-b-PAA₄₃ ([carboxylic acid]=0.83 mM) in aqueous solution, respectively. (Entry no. 4 in Table 1: Complex 1 is shown in Formula 2 and the anion, X⁻, is PF₆⁻).

FIG. 13 shows the selected area electron diffraction pattern (SAED) of rigid rod-like segment on the intermediate tri-block heterostructures during the formation of penta-block supramolecular heterostructure formed from co-assembly of supramolecular polymers of complex 1 (0.20 mM)+PEG₄₅-b-PAA₄₃ ([carboxylic acid]=1.0 mM) in aqueous solution, respectively. (Entry no. 3 in Table 1: Complex 1 is shown in Formula 2 and the anion, X⁻, is PF₆⁻).

FIG. 14 shows the SAED of flexible coil-like segment on the intermediate tri-block heterostructures during the formation of penta-block supramolecular heterostructure formed from co-assembly of supramolecular polymers of complex 1 (0.20 mM)+PEG₄₅-b-PAA₄₃ ([carboxylic acid]=1.0 mM) in aqueous solution, respectively. (Entry no. 3 in Table 1: Complex 1 is shown in Formula 2 and the anion, X⁻, is PF₆⁻).

FIG. 15 shows the atomic force microscopic image and height profile of the penta-block supramolecular heterostructure formed from co-assembly of supramolecular polymers of complex 1 (0.20 mM)+PEG₄₅-b-PAA₄₃ ([carboxylic acid]=1.0 mM) in aqueous solution, respectively. (Entry no. 3 in Table 1: Complex 1 is shown in Formula 2 and the anion, X⁻, is PF₆⁻).

FIG. 16 shows the selectively-stained transmission electron microscopic (TEM) image of intermediate tri-block heterostructures during the formation of penta-block supramolecular heterostructure formed from co-assembly of supramolecular polymers of complex 1 (0.20 mM)+PEG₄₅-b-PAA₄₃ ([carboxylic acid]=1.0 mM) in aqueous solution, respectively. (Entry no. 3 in Table 1: Complex 1 is shown in Formula 2 and the anion, X⁻, is PF₆⁻). The TEM sample was negatively stained by phosphotungstic acid before observation.

FIG. 17 shows the SEM image of rod-loop heterostructures formed from co-assembly of supramolecular polymers of complex 1 (0.15 mM)+PEG₄₅-b-PAA₄₃ ([carboxylic acid]=1.08 mM) in aqueous solution by stepwise addition of block polymers, respectively. (Entry no. 5 in Table 1: Complex 1 is shown in Formula 2 and the anion, X⁻, is PF₆⁻).

FIG. 18 shows the SEM image of linear multi-segmented heterostructures formed from co-assembly of supramolecular polymers of complex 1 (0.3 mM)+PEG₄₅-b-PAA₄₃ ([carboxylic acid]=1.5 mM) in aqueous solution. (Entry no. 6 in Table 1: Complex 1 is shown in Formula 2 and the anion, X⁻, is PF₆⁻).

FIG. 19 shows the SEM image of branched multi-segmented heterostructures formed from co-assembly of supramolecular polymers of complex 1 (0.3 mM)+PEG₄₅-b-PAA₄₃ ([carboxylic acid]=3.0 mM) in aqueous solution. (Entry no. 7 in Table 1: Complex 1 is shown in Formula 2 and the anion, X⁻, is PF₆⁻).

FIG. 20 shows the SEM image of penta-block heterostructures formed from co-assembly of supramolecular polymers of complex 1 (0.12 mM)+PEG₄₅-b-PAA₆₀ ([carboxylic acid]=1.08 mM) in aqueous solution. (Entry no. 8 in Table 1: Complex 1 is shown in Formula 2 and the anion, X⁻, is PF₆⁻).

FIG. 21 shows the SEM image of penta-block heterostructures formed from co-assembly of supramolecular polymers of complex 1 (0.12 mM)+PEG₄₅-b-PAA₁₀₀ ([carboxylic acid]=1.08 mM) in aqueous solution. (Entry no. 9 in Table 1: Complex 1 is shown in Formula 2 and the anion, X⁻, is PF₆⁻).

FIG. 22 shows the SEM image of penta-block heterostructures formed from co-assembly of supramolecular polymers of complex 2 (0.15 mM)+PEG₄₅-b-PAA₅₀ ([carboxylic acid]=0.60 mM) in aqueous solution. (Entry no. 11 in Table 1: Complex 2 is shown in Formula 4 and the anion, X⁻, is PF₆⁻).

FIG. 23 shows the SEM image of penta-block heterostructures formed from co-assembly of supramolecular polymers of complex 2 (0.15 mM)+PEG45-b-PAA50 ([carboxylic acid]=0.60 mM) in aqueous solution. (Entry no. 11 in Table 1: Complex 2 is shown in Formula 4 and the anion, X⁻, is PF₆⁻).

FIG. 24 shows the SEM image of penta-block heterostructures formed from co-assembly of supramolecular polymers of complex 4 (0.15 mM)+PEG₄₅-b-PAA₅₀ ([carboxylic acid]=0.60 mM) in aqueous solution, respectively. (Entry no. 12 in Table 1: Complex 4 is shown in Formula 8 and the anion, X⁻, is PF₆⁻).

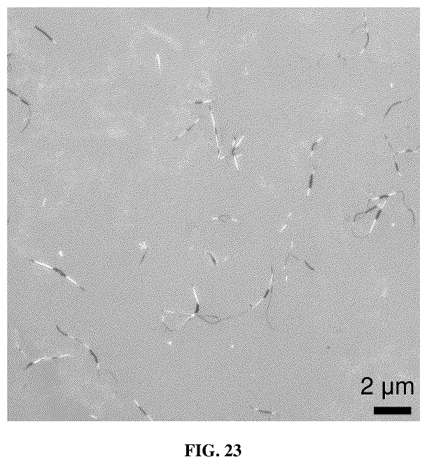

FIG. 25 shows the SEM image of tri-block heterostructures formed from co-assembly of supramolecular polymers of complex 3 (0.15 mM)+PEG₄₅-b-PAA₅₀ ([carboxylic acid]=0.60 mM) in aqueous solution. (Entry no. 13 in Table 1: Complex 2 is shown in Formula 4 and the anion, X⁻, is PF₆⁻).

FIG. 26 shows the SEM image of tri-block heterostructures formed from co-assembly of supramolecular polymers of complex 1 (0.15 mM)+PEG₄₅-b-PAA₄₃ ([carboxylic acid]=0.60 mM) in aqueous solution. (Entry no. 14 in Table 1: Complex 1 is shown in Formula 2 and the anion, X⁻, is PF₆⁻).

FIG. 27 shows the SEM image of tri-block heterostructures formed from co-assembly of supramolecular polymers of complex 4 (0.15 mM)+PEG₄₅-b-PAA₅₀ ([carboxylic acid]=0.60 mM) in aqueous solution. (Entry no. 15 in Table 1: Complex 4 is shown in Formula 8 and the anion, X⁻, is PF₆⁻).

FIG. 28 shows the SEM image of tri-block heterostructures formed from co-assembly of supramolecular polymers of complex 4 (0.15 mM)+PEG₄₅-b-PAA₅₀ ([carboxylic acid]=0.60 mM) in aqueous solution. (Entry no. 16 in Table 1: Complex 4 is shown in Formula 8 and the anion, X⁻, is perchloride (ClO₄⁻).

FIG. 29 shows the TEM image of penta-block heterostructures formed from co-assembly of complex 1 (0.04 mM)+complex 2 (0.15 mM)+PEG₄₅-b-PAA₅₀ ([carboxylic acid]=0.50 mM) in aqueous solution. (Entry no. 17 in Table 1: Complex 1 is shown in Formula 2, complex 2 is shown in Formula 4 and the anions, X⁻, are PF₆⁻ for both complexes).

FIG. 30 shows the SEM image of hepta-block heterostructures formed from co-assembly of complex 1 (0.05 mM)+complex 2 (0.04 mM)+PEG₄₅-b-PAA₄₃ ([carboxylic acid]=0.54 mM) in aqueous solution. (Entry no. 18 in Table 1: Complex 1 is shown in Formula 2, complex 2 is shown in Formula 4 and the anions, X⁻, is PF₆⁻ for complex 1 and ClO₄⁻ for complex 2).

FIG. 31 shows the elemental mapping images of hepta-block heterostructures formed from co-assembly of complex 1 (0.05 mM)+complex 2 (0.04 mM)+PEG₄₅-b-PAA₅₀ ([carboxylic acid]=0.54 mM) in aqueous solution. (Entry no. 18 in Table 1: Complex 1 is shown in Formula 2, complex 2 is shown in Formula 4 and the anions, X⁻, is PF₆⁻ for complex 1 and ClO₄⁻ for complex 2).

FIG. 32 shows the SEM image of hepta-block heterostructures formed from co-assembly of complex 1 (0.04 mM)+complex 2 (0.05 mM)+PEG₄₅-b-PAA₅₀ ([carboxylic acid]=0.54 mM) in aqueous solution. (Entry no. 19 in Table 1: Complex 1 is shown in Formula 2, complex 2 is shown in Formula 4 and the anions, X⁻, are PF₆⁻ for both the two complexes).

FIG. 33 shows the elemental mapping images of hepta-block heterostructures formed from co-assembly of complex 1 (0.04 mM)+complex 2 (0.05 mM)+PEG₄₅-b-PAA₅₀ ([carboxylic acid]=0.54 mM) in aqueous solution. (Entry no. 19 in Table 1: Complex 1 is shown in Formula 2, complex 2 is shown in Formula 4 and the anions, X⁻, are PF₆⁻ for both complexes).

FIG. 34 shows the SEM image of multi-segmented heterostructures formed from co-assembly of complex 1 (0.15 mM)+complex 2 (0.04 mM)+PEG₄₅-b-PAA₅₀ ([carboxylic acid]=1.0 mM) in aqueous solution. (Entry no. 20 in Table 1: Complex 1 is shown in Formula 2, complex 2 is shown in Formula 4 and the anions, X⁻, is PF₆⁻ for complex 1 and ClO₄⁻ for complex 2).

FIG. 35 shows the elemental mapping images of multi-segmented heterostructures formed from co-assembly of complex 1 (0.15 mM)+complex 2 (0.04 mM)+PEG₄₅-b-PAA₅₀ ([carboxylic acid]=1.0 mM) in aqueous solution. (Entry no. 20 in Table 1: Complex 1 is shown in Formula 2, complex 2 is shown in Formula 4 and the anions, X⁻, is PF₆⁻ for complex 1 and ClO₄⁻ for complex 2).

FIG. 36 shows the SEM image of multi-segmented heterostructures formed from co-assembly of complex 1 (0.04 mM)+complex 2 (0.15 mM)+PEG₄₅-b-PAA₅₀ ([carboxylic acid]=0.54 mM) in aqueous solution. (Entry no. 21 in Table 1: Complex 1 is shown in Formula 2, complex 2 is shown in Formula 4 and the anions, X⁻, is PF6⁻ for both complexes).

FIG. 37 shows the elemental mapping images of multi-segmented heterostructures formed from co-assembly of complex 1 (0.04 mM)+complex 2 (0.15 mM)+PEG₄₅-b-PAA₅₀ ([carboxylic acid]=1.0 mM) in aqueous solution. (Entry no. 21 in Table 1: Complex 1 is shown in Formula 2, complex 2 is shown in Formula 4 and the anions, X⁻, is PF₆⁻ for both complexes).

FIG. 38 shows an SEM image of tri-block heterostructures with a loop-rod-loop topology formed from co-assembly of supramolecular polymers of complex 1 (0.30 mM)+PEG₄₅-b-PAA₅₀ ([carboxylic acid]=1.0 mM) in aqueous solution, respectively. (Entry no. 1 in Table 2: Complex 1 is shown in Formula 2 and the anion, X⁻, is hexafluorophosphate PF₆⁻).

FIG. 39 shows an SEM image of penta-block heterostructures with a loop-rod-loop-rod-loop topology formed from co-assembly of supramolecular polymers of complex 1 (0.30 mM)+PEG₄₅-b-PAA₅₀ ([carboxylic acid]=1.0 mM) in aqueous solution, respectively. (Entry no. 2 in Table 2: Complex 1 is shown in Formula 2 and the anion, X⁻, is hexafluorophosphate PF₆⁻).

FIG. 40 shows an SEM image of unsymmetric diblock heterostructures with a rod-coil topology formed from co-assembly of supramolecular polymers of complex 1 (0.30 mM)+PEG₄₅-b-PAA₃₅ ([carboxylic acid]=1.0 mM) in aqueous solution, respectively. (Entry no. 3 in Table 2: Complex 1 is shown in Formula 2 and the anion, X⁻, is hexafluorophosphate PF₆⁻).

FIG. 41 shows a TEM image of unsymmetric diblock heterostructures with a rod-loop topology formed from co-assembly of supramolecular polymers of complex 1 (0.30 mM)+PEG₄₅-b-PAA₅₀ ([carboxylic acid]=1.0 mM) in aqueous solution, respectively. (Entry no. 4 in Table 2: Complex 1 is shown in Formula 2 and the anion, X⁻, is hexafluorophosphate PF₆⁻).

FIG. 42 shows an SEM image of tri-block heterostructures with a rod-coil-rod topology formed from co-assembly of supramolecular polymers of complex 2 (0.30 mM)+PEG₄₅-b-PAA₃₅ ([carboxylic acid]=0.75 mM) in aqueous solution, respectively. (Entry no. 5 in Table 2: Complex 2 is shown in Formula 4 and the anion, X⁻, is hexafluorophosphate PF₆⁻).

FIG. 43 shows an SEM image of penta-block heterostructures formed from co-assembly of supramolecular polymers of complex 2 (0.15 mM)+PEG₄₅-b-PAA₃₅ ([carboxylic acid]=0.75 mM) in aqueous solution, respectively. (Entry no. 6 in Table 2: Complex 2 is shown in Formula 4 and the anion, X⁻, is hexafluorophosphate PF₆⁻).

FIG. 44 shows an SEM image of multi-block heterostructures formed from co-assembly of supramolecular polymers of complex 2 (0.20 mM)+PEG₄₅-b-PAA₃₅ ([carboxylic acid]=1.5 mM) in aqueous solution, respectively. (Entry no. 7 in Table 2: Complex 2 is shown in Formula 4 and the anion, X⁻, is hexafluorophosphate PF₆⁻).

FIG. 45 shows an SEM image of tri-block heterostructures with a rod-coil-rod topology formed from co-assembly of supramolecular polymers of complex 2 (0.15 mM)+PEG₁₁₄-b-PAA₅₀ ([carboxylic acid]=0.75 mM) in aqueous solution, respectively. (Entry no. 8 in Table 2: Complex 2 is shown in Formula 4 and the anion, X⁻, is hexafluorophosphate PF₆⁻).

FIG. 46 shows an SEM image of coaxial heterostructures formed from co-assembly of supramolecular polymers of complex 2 (0.15 mM)+PEG₄₅-b-PAA₅₀ ([carboxylic acid]=1.0 mM) in aqueous solution, respectively. (Entry no. 9 in Table 2: Complex 2 is shown in Formula 4 and the anion, X⁻, is hexafluorophosphate ClO₄⁻).

### DETAILED DESCRIPTION OF THE INVENTION

The disclosed method and compositions may be understood more readily by reference to the following detailed description of particular embodiments and the Example included therein and to the Figures and their previous and following descriptions.

### I. Definitions

The phrase “active ends” refers to a terminus of a structure, such as a nanostructure, that is capable of undergoing hierarchical self-assembly in an end-to-end manner based on interactions such as metal-metal interactions, π-π interactions, hydrogen-bonding interactions, solvophobic-solvophobic interactions, or a combination thereof.

The phrase “nanostructure” refers to ordered structures of any possible geometry with at least one of the dimensions in the range of 1-1000 nm. Non-limiting examples of the morphology of the ordered structures include spherical, cylindrical, rod-like, disk-like, wheel-like, tube-like, leaf-like, cube-like, and fibrous structures. For example, the terms “nanofibers,” “nanowires,” “nanorods”, “nano-ribbons”, and “nano-belts” refer to ordered structures with a length substantially greater than the width/thickness, and the width/thickness is in the range of 1-1000 nm. The term “nano-loops” refer to ordered structures with a width and thickness in the range of 1-1000 nm.

The term “spatially distinct features” refers to objects that contain different domains possessing different chemical compositions, stiffness, packing densities, and/or topologies.

The term “heterostructure” herein refers to a supramolecular object containing heterogeneous zones with distinctive chemical, mechanical and/or physical properties.

The term “supramolecular polymerization” refers to polymerization of solvophobic small molecular components with a planar or linear geometry based on non-covalent interactions to afford well-defined supramolecular polymers.

The term “solvophobic” herein refers to a substance or component that is not soluble or have poor solubility in a specific solvent. The term “solvophilic” herein refers to a substance or component that is soluble in a specific solvent. When the solvent is water or an aqueous medium, the terms solvophobic and solvophilic correspond to “hydrophobic” and “hydrophilic”, respectively.

The term “small molecule component” herein refers to small molecules generally of a molecular weight of less than 3,000 Da. The molecular weight is between about 50 Da and about 3,000 Da, between about 50 Da and about 2,500 Da, between about 50 Da and about 2,000 Da, between about 50 Da and about 1,500 Da, between about 50 Da and about 1,000 Da, between about 50 Da and about 800 Da, between about 50 Da and about 500 Da. In some forms, small molecules are non-polymeric and/or non-oligomeric. In the case of components used to form the disclosed supramolecular polymers, small-molecule components are generally planar or linear in configuration and can associate or interact with one another non-covalently. Such non-covalent associations and interactions of small-molecule components can be, for example, π-π interactions, hydrogen bonding interactions, metal-metal interactions, solvophobic-solvophobic interactions (such as hydrophobic-hydrophobic interactions) between two or more of the small-molecule components. In some forms, the “small-molecule components” can be, for example, metal complexes coordinated with ligands in a coplanar or linear arrangement or organic small molecules generally having one or more non-saturated aryl groups. The metal complexes can involve one, two, three or more metal centers.

The term “polymer component” herein refers to polymers formed by covalent bonding of a plurality of repeating units. In the case of components used to form the disclosed supramolecular polymers, the polymer component can interact with the small-molecule components in forming the supramolecular polymers or copolymers.

The terms “ligand” and “metal coordination ligand” herein refer to ions or molecules that can bind to metal centers, non-metal centers, or transition-metal centers to form coordination complexes. The number of ligand atoms bound to the metal centers, transition metal centers, or non-metal centers is called the coordination number. Any ion or molecule with a pair of nonbonding electrons can be a ligand. Many ligands are described as monodentate (e.g., “one-toothed”) because they “bite” the metal in only one place. Monodentate ligands refer to ligands that have only one donor atom that can coordinate to the central atom. Bidentate ligands refer to ligands that have two donor atoms. Tridentate ligands refer to ligands that have three donor atoms attached to the same metal center. Tetradentate ligands refer to ligands that have four donor atoms. The term “chelate” means “claw” from its Greek stem and is used to describe ligands that can grab the central atom (metal center, transition-metal center, or non-metal center) in two or more places.

The term “supramolecular polymer” herein refers to assemblies whose building blocks are held together by non-covalent interactions. Examples of building blocks include molecules, macromolecules, metal complexes, ions, nanoparticles or a combination of them. Non-limiting examples of supramolecular polymers include coiled chains connected by non-covalent interactions, nanofibers of peptide amphiphiles, worm-like micelles of block copolymers, assemblies of block copolymers, or one-dimensional nanoparticulate assemblies.

The term “co-assembly” herein refers to the formation of ordered structures from small molecules, conjugates or complexes (e.g., the planar d⁸ or d¹⁰ metal complexes) through non-covalent supramolecular interactions. Non-limiting examples of non-covalent supramolecular interactions include hydrophobic-hydrophobic interactions, π-π interactions, hydrogen bonding, metal-metal interactions, C—H ⋅ ⋅ ⋅ O interactions and C—H ⋅ ⋅ ⋅ X (where X⁻ is F or Cl) interactions, etc.

The term “alkyl group” as used herein is a branched or unbranched saturated hydrocarbon group of 1 to 30 carbon atoms, such as methyl, ethyl, n-propyl, isopropyl, n-butyl, isobutyl, t-butyl, pentyl, hexyl, heptyl, octyl, decyl, tetradecyl, hexadecyl, eicosyl, tetracosyl and the like.

The term “alkoxy” as used herein is an alkyl group bound through a single, terminal ether linkage; that is, an “alkoxy” group can be defined as —OR where R is alkyl as defined above.

The term “alkenyl group” as used herein is a hydrocarbon group of from 2 to 30 carbon atoms and structural formula containing at least one carbon-carbon double bond.

The term “alkynyl group” as used herein is a hydrocarbon group of 2 to 30 carbon atoms and a structural formula containing at least one carbon-carbon triple bond.

The terms “amino” and “amine” refer to both substituted and unsubstituted amines.

The term “aryl group” as used herein is any carbon-based aromatic group including, but not limited to, benzene, naphthalene, etc. The term “aromatic” also includes “heteroaryl group” which is defined as an aromatic group that has at least one heteroatom incorporated within the ring of the aromatic group. Examples of heteroatoms include, but are not limited to, nitrogen, oxygen, sulfur, and phosphorus. The aryl group can be substituted or unsubstituted. The aryl group can be substituted with one or more groups including, but not limited to, alkyl, alkynyl, alkenyl, aryl, halide, nitro, amino, ester, ketone, aldehyde, hydroxy, carboxylic acid, or alkoxy.

The term “aryloxy” as used herein is an aryl group bound through a single, terminal ether linkage; that is, an “aryloxy” group can be defined as —OR where R is aryl as defined above.

The term “cycloalkyl group” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl group” is a cycloalkyl group as defined above where at least one of the carbon atoms of the ring is substituted with a heteroatom such as, but not limited to, nitrogen, oxygen, sulphur, or phosphorus.

The term “arylalkyl” as used herein is an aryl group having an alkyl, alkynyl, or alkenyl group as defined above attached to the aromatic or heteroaromatic group.

The term “alkoxyalkyl group” is defined as an alkyl, alkenyl, alkynyl, aryl, arylalkyl, cycloalkyl, halogenated alkyl, or heterocycloalkyl group described above that has at least one hydrogen atom substituted with an alkoxy group described above.

The term “ester” as used herein is represented by the formula —C(O)OA, where A can be an alkyl, halogenated alkyl, alkenyl, alkynyl, aryl, heteroaryl, cycloalkyl, cycloalkenyl, heterocycloalkyl, or heterocycloalkenyl group described above.

The term “carbonate group” as used herein is represented by the formula —OC(O)OR, where R can be hydrogen, an alkyl, alkenyl, alkynyl, aryl, arylalkyl, cycloalkyl, halogenated alkyl, or heterocycloalkyl group described above.

The term “carboxylic acid” as used herein is represented by the formula —C(O)OH; the term “carboxylate” as used herein is represented by —C(O)O.

The term “aldehyde” as used herein is represented by the formula —C(O)H.

The term “keto group” as used herein is represented by the formula —C(O)R, where R is an alkyl, alkenyl, alkynyl, aryl, arylalkyl, cycloalkyl, halogenated alkyl, heteroalkyl or heterocycloalkyl group described above.

The term “carbonyl group” as used herein is represented by the formula —C═O.

The term “ether” as used herein is represented by the formula AOA₁, where A and A₁ can be, independently, an alkyl, halogenated alkyl, heteroalkyl, alkenyl, alkynyl, aryl, heteroaryl, cycloalkyl, cycloalkenyl, heterocycloalkyl, or heterocycloalkenyl group described above.

The term “silyl group” as used herein is represented by the formula —SiRR′R″, where R, R′, and R″ can be, independently, hydrogen, an alkyl, alkenyl, alkynyl, aryl, arylalkyl, cycloalkyl, halogenated alkyl, alkoxy, or heterocycloalkyl group described above.

The term “sulfo-oxo group” as used herein is represented by the formulas —S(O)₂R, OS(O)₂R, or, —OS(O)₂OR, where R can be hydrogen, an alkyl, alkenyl, alkynyl, aryl, arylalkyl, cycloalkyl, halogenated alkyl, or heterocycloalkyl group described above.

The terms “substituent” and “substitute” as used herein refers to all permissible substituents of the compounds or functional groups described herein. The term “substituted” refers to a compound that has one group (usually a hydrogen, carbon, or nitrogen) substituted with a substituent. The term “substituted with” in connection with a compound, structure, R group, etc., refers to substituents of the referenced compound, structure, R group, etc. In the broadest sense, the permissible substituents include acyclic and cyclic, branched and unbranched, carbocyclic and heterocyclic, aromatic and nonaromatic substituents of organic compounds. Illustrative substituents include, but are not limited to, halogens, hydroxyl groups, or any other organic groupings containing any number of carbon atoms, preferably 1-14 carbon atoms, and optionally include one or more heteroatoms such as oxygen, sulfur, or nitrogen grouping in linear, branched, or cyclic structural formats. Representative substituents include alkyl, substituted alkyl, alkenyl, substituted alkenyl, alkynyl, substituted alkynyl, phenyl, substituted phenyl, aryl, substituted aryl, heteroaryl, substituted heteroaryl, halo, hydroxyl, arylalkyl, substituted arylalkyl, alkoxy, substituted alkoxy, phenoxy, substituted phenoxy, aryloxy, substituted aryloxy, alkylthio, substituted alkylthio, phenylthio, substituted phenylthio, arylthio, substituted arylthio, cyano, isocyano, substituted isocyano, carbonyl, substituted carbonyl, carboxyl, substituted carboxyl, amino, substituted amino, amido, substituted amido, sulfonyl, substituted sulfonyl, sulfonic acid, phosphoryl, substituted phosphoryl, phosphonyl, substituted phosphonyl, polyaryl, substituted polyaryl, C₃-C₂₀ cyclic, substituted C₃-C₂₀ cyclic, heterocyclic, substituted heterocyclic, amino acid, poly(lactic-co-glycolic acid), peptide, and polypeptide groups. Such alkyl, substituted alkyl, alkenyl, substituted alkenyl, alkynyl, substituted alkynyl, phenyl, substituted phenyl, aryl, substituted aryl, heteroaryl, substituted heteroaryl, halo, hydroxyl, arylalkyl, substituted arylalkyl, alkoxy, substituted alkoxy, phenoxy, substituted phenoxy, aryloxy, substituted aryloxy, alkylthio, substituted alkylthio, phenylthio, substituted phenylthio, arylthio, substituted arylthio, cyano, isocyano, substituted isocyano, carbonyl, substituted carbonyl, carboxyl, substituted carboxyl, amino, substituted amino, amido, substituted amido, sulfonyl, substituted sulfonyl, sulfonic acid, phosphoryl, substituted phosphoryl, phosphonyl, substituted phosphonyl, polyaryl, substituted polyaryl, C₃-C₂₀ cyclic, substituted C₃-C₂₀ cyclic, heterocyclic, substituted heterocyclic, amino acid, poly(lactic-co-glycolic acid), peptide, and polypeptide groups can be further substituted.

The term unsubstituted “Cₓ” in reference to a compound, substituent, moiety, etc., refers to a compound, substituent, moiety, etc., having x carbon atoms.

The term unsubstituted “C_{y}-Cₓ” in reference to a compound, substituent, moiety, etc., refers to a compound, substituent, moiety, etc., having from y to x carbon atoms, inclusive. For example, C₁-C₈ alkyl is an alkyl having from 1 to 8 carbon atoms, inclusive.

### II. Compositions

Disclosed are compositions and methods relating to supramolecular nanostructures with spatially distinct features, their formation, and their use.

In some forms, the supramolecular nanostructures include multiple small-molecule components and a polymer component. In general, the solvophobic small-molecule components have a planar or linear geometry, while the supramolecular polymer, are formed from association of the components non-covalently based on, but not limited to, metal-metal interactions, π-π interactions, hydrogen-bonding interactions, solvophobic-solvophobic interactions, or a combination thereof. In general, the polymer component is solvophilic and the supramolecular polymer involves the formation of non-covalent interaction with some or all of the small-molecule components.

Generally, the supramolecular nanostructures have segmented compositions where the rigid segments with structural order, preferably crystalline to semi-crystalline, are composed of small-molecule components and the flexible segments are composed of small-molecule components and polymer components. Rigidity can be determined via observation and structural orderliness. The rigid segment with structural order, preferably crystalline to semi-crystalline, contains small molecules and exhibits needle-like shape, while the segment containing small molecules and polymers are featured with thin-layer nanostructure and are less ordered. Generally, the rigid segments are formed by small-molecule components with a planar or linear geometry, are solvophobic, and can interact with one another non-covalently based on metal-metal interactions, π-π interactions, hydrogen-bonding interactions, solvophobic-solvophobic interactions, or a combination thereof. The flexible segments are formed from co-assembly of the polymer components and small-molecule components at specific regions of the preformed rigid supramolecular polymers. In some forms, the small-molecule components on both the rigid and flexible segments can be the same, different, or a combination, depending on the co-assembly process of the small-molecule components in the supramolecular polymer and polymer component.

In some forms, the rigid segments on the supramolecular nanostructure composes of nano-rods. The flexible segments on the supramolecular nanostructure can be in the form of, for example, nanofibers, nano-belts, nano-ribbons, or nano-loops.

In some forms, the flexible segments of the supramolecular nanostructure can compose of a core-shell structure, where the shell contains at least a portion of the polymer component and the core contains both the small-molecule components and polymer components.

Also disclosed are methods of forming supramolecular nanostructure. In some forms, the method includes incubating small-molecule components and a polymer component in a solvent for a period of time effective to induce formation of supramolecular nanostructures.

Generally, the small-molecule components used in the methods have a planar or linear geometry, are preferably, but not limited to being, solvophobic, and can associate with one another non-covalently based on metal-metal interactions, π-π interactions, hydrogen-bonding interactions, solvophobic-solvophobic interactions, or a combination thereof.

Generally, the polymer component used in the methods is preferably, but not limited to being, solvophilic and can interact with some or all of the small-molecule components non-covalently to stabilize the supramolecular nanostructures formed.

Generally, the supramolecular nanostructures formed by the methods contain flexible segments and are capable of selective spatial co-assembly upon addition of additional guest small-molecule components.

In some forms, the flexible segments of the supramolecular nanostructure formed by the methods composes of one or more nanostructures, wherein the nanostructure is in the form of nanofibers, nano-belts, nano-ribbons, or nano-loops. In some forms, the flexible segments of the supramolecular nanostructure formed contain a core-shell structure, where the shell contains at least a portion of the polymer component and the core contains the small-molecule components and polymer components.

In some forms, the method can further involve the selective spatial co-assembly of the supramolecular nanostructures formed by incubating additional small-molecule components to the flexible segments in the formed supramolecular nanostructures. Generally, the additional small-molecule components have a planar or linear geometry and associate non-covalently with another small molecules, or the small-molecule components in the formed supramolecular polymer, or both. Generally, the polymer component interacts with the additional small-molecule components. In some forms, the additional small-molecule components are different from the small-molecule components of the formed supramolecular polymers.

In some forms, the solvent is water.

In some forms, the method can further involve fabricating aligned metal nanoparticles or nanopatterns using the formed supramolecular nanostructure as a precursor.

The supramolecular co-assembly process generally involves at least two steps: firstly, preparing the supramolecular polymers of preferably, but not limited to being, solvophobic small-molecule components with planar or linear geometry as precursors and then inducing co-assembly by adding a preferably, but not limited to being, solvophilic polymer component. In some forms in an aqueous medium, the planar or linear small molecule is hydrophobic and the polymer component is hydrophilic and soluble in water. Non-limiting non-covalent interactions such as metal-metal interactions, π-π interactions, hydrogen-bonding interactions, solvophobic-solvophobic (or hydrophobic-hydrophobic) interactions, or a combination of different interactions between the planar or linear small molecules direct the growth of supramolecular polymers, and the polymer component interacts with the planar or linear small molecules by electrostatic interactions and stabilizes the supramolecular nanostructures formed. After supramolecular co-assembly, the co-assembled flexible segments composed of small-molecule components and polymer components remain connected to the residual parts of the supramolecular polymer (precursors) to produce a supramolecular heterostructure. In some forms, supramolecular copolymers are used as the precursors for subsequent co-assembly of polymer components and small-molecule components in the preformed supramolecular copolymer to produce supramolecular block co-micelles. Supramolecular heterostructures and supramolecular block co-micelles can have various compositions, controlled dimensions, and different architectures. The supramolecular nanostructures obtained exhibit rich spectroscopic and luminescence properties as well as other functional properties. Furthermore, the supramolecular heterostructures in the solution state exhibit selective spatial co-assembly properties.

The two-component supramolecular co-assembly is realized by cooperative self-assembly of the supramolecular polymers formed by small-molecule components and the polymer components. The small-molecule components which are preferably, but not limited to being, solvophobic and exhibit strong tendency to associate with each other to form rigid supramolecular polymers through non-limiting non-covalent interactions such as metal-metal interactions, π-π interactions, hydrogen-bonding interactions, solvophobic-solvophobic (or hydrophobic-hydrophobic) interactions, or a combination of different interactions, and the polymer components which are preferably, but not limited to being, solvophilic and can interact with the small-molecule components in the preformed supramolecular polymers at some specific regions non-covalently, are used. For example, mixing a solution of hydrophobic small molecules in a water-miscible organic solvent (such as acetonitrile, acetone, methanol, THF or DMSO) with aqueous solution of hydrophilic polymers leads to the supramolecular polymerization of the hydrophobic small molecules. The formed supramolecular polymers can undergo co-assembly with the hydrophilic polymers into ordered nanostructures in aqueous solution. The supramolecular co-assembly occurs at some specific regions of the supramolecular polymers where the small-molecule components are relatively loosely packed. The co-assembly is driven by non-covalent interactions, such as, but not limited to, metal-metal interactions, π-π interactions, hydrogen-bonding interactions, hydrophobic-hydrophobic interactions, electrostatic interactions, or a combination of different interactions between the hydrophobic small molecules.

The hydrophobic (solvophobic) small molecules in solution can undergo spontaneous supramolecular polymerization to form ordered structures directed by non-limiting non-covalent interactions such as metal-metal interactions, π-π interactions, hydrophobic-hydrophobic (solvophobic-solvophobic) interactions, or a combination of different interactions. In the presence of hydrophilic (solvophilic) polymers, the polymers can interact with the hydrophobic (solvophobic) small molecules to form flexible supramolecular assemblies. The use of hydrophilic small molecules and hydrophobic polymers is also contemplated, depending on the solvent conditions. For instance, in media with high water content or highly polar solvent, the combination of hydrophobic small molecules and hydrophilic polymers is applicable; alternatively, in non-polar solvents, hydrophilic small molecules and hydrophobic polymers are applicable. Driven by the electrostatic interactions between polymers and small molecules, the monomers of small molecules can undergo co-assembly with polymers to form co-assemblies rather than undergoing supramolecular polymerization to form supramolecular polymers by themselves. Therefore, when the disclosed two-step co-assembly strategy is conducted to induce the co-assembly of small molecules and polymers, some regions of the preformed supramolecular polymers of small molecules bearing oppositely charged groups can reconfigure into co-assemblies by interacting with polymers at some regions of the polymers. The non-covalent interactions involved that direct the growth of co-assemblies render it possible for the co-assemblies to connect with the residual parts of the supramolecular polymers. As a result, supramolecular heterostructures containing rigid segments of small molecules and flexible segments of co-assembled small molecules and polymers are formed.

Both steps (i.e., the supramolecular polymerization of the small-molecule components and the co-assembly of preformed supramolecular polymers and polymer components) for the disclosed two-step co-assembly process can be modulated. In some forms, the initial concentration of small-molecule components can be varied to control the length of the supramolecular polymers (precursors). The length of the precursors can be reduced by sonication. In some forms, the precursors of supramolecular polymers can be prepared by blending two or more kinds of small molecules to enrich the composition of the precursors. In some forms, a seeded growth procedure can be utilized to prepare supramolecular copolymers as the precursors for co-assembly. The kinetics of the co-assembly of precursors and polymer components can also be tuned to control the architecture, compositions, as well as dimensions of the resulting supramolecular nanostructures. The feed ratio of the polymer components to small-molecule components can be changed to tune the relative length of rigid and flexible segments. In some forms, the addition rate of polymer components to the solution of supramolecular polymers can be tuned to control the dimension of the supramolecular nanostructures. In some forms, temperature can be tuned to control the co-assembly kinetics and thus manipulate the resulting supramolecular nanostructures.

The processing utilizes a two-component system to perform supramolecular co-assembly toward the construction of supramolecular nanostructures with spatially distinct features rather than a single-component system as the existing methods in the literature do. The existing methods based on single-component systems largely depend on the synthesis of some specially designed molecules or macromolecules to realize a living supramolecular polymerization. This is believed to be the reason for the rather limited types of supramolecular monomers in the field of living supramolecular polymerization. The processing herein uses polymer-small molecule pairs to perform the supramolecular co-assembly. The small molecules and the polymers can be designed and synthesized independently. This new and/or improved strategy endows the processing with large flexibility as the requirements for the supramolecular monomers are very general. The two-component supramolecular co-assembly involves: 1) the supramolecular monomers exhibiting strong tendency to associate with each other via intermolecular interactions; 2) the supramolecular monomers interacting with the polymers non-covalently. Based on this new and/or improved strategy, this disclosure largely broadens the scope of supramolecular monomers in the field of supramolecular co-assembly toward the construction of segmented nanostructures. Furthermore, because the small molecules and the polymers can be designed and synthesized independently, the present invention requires fewer synthetic efforts and thus reduces the cost for the preparation and simplifies the process. Specifically, in the embodiments, the major driving force for the supramolecular co-assembly is the non-covalent interactions such as, but not limited to, metal-metal interactions, π-π interactions, hydrogen-bonding interactions, solvophobic-solvophobic (or hydrophobic-hydrophobic) interactions, electrostatic interactions, or a combination of different interactions between the small molecules. It is known that many metal complexes of square-planar, trigonal-planar and linear configurations as well as planar organic molecules show strong tendency to associate with each other through non-covalent metal-metal interactions, π-π interactions, hydrogen-bonding interactions, solvophobic-solvophobic (or hydrophobic-hydrophobic) interactions, electrostatic interactions, or a combination of different interactions. Therefore, the process allows the supramolecular polymerization of a variety of planar or linear small molecules to prepare the precursors for further co-assembly.

The processing utilizes a two-step procedure for the two-component system to construct supramolecular nanostructures with spatially distinct features rather than a one-step co-assembly strategy as the existing methods in the literature do. Ordered architectures are already formed from the supramolecular polymerization of the small-molecule components in the first step of the disclosed two-step procedure. Meanwhile, the co-assembly of polymer components and small-molecule components occurs in situ on the specific region of the preformed supramolecular polymers. As a result, the intermediate during the co-assembly process (second step) is preferred to be an integrated architecture composed of the supramolecular polymers formed in the first step and co-assemblies formed in the second step. Therefore, supramolecular nanostructures with spatially distinct features are readily formed through the disclosed strategy when the co-assembly process is under kinetical control.

A. Solvophobic Small Molecules with Planar or Linear Geometry

The small molecule components that exhibit strong tendency to associate with each other through non-limiting non-covalent interactions such as metal-metal interactions, π-π interactions, hydrogen-bonding interactions, solvophobic-solvophobic (or hydrophobic-hydrophobic) interactions, or a combination of different interactions can be used for living supramolecular polymerization. In some embodiments, the small-molecule components include molecules that are symmetrical or unsymmetrical and have a planar configuration.

### 1. Metal Complexes

In some forms, the small-molecule components suitable for preparation of the precursors of supramolecular polymers from supramolecular polymerization in the first step include metal complexes of a square planar configuration with monodentate, bidentate, tridentate or tetradentate ligands, represented by the following general formula,

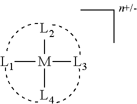

wherein:
(a) M is Ni(II), Pd(II), Pt(II), Rh(I), Ir(I), Au(III), Cu(III), Zn(II) or Cu(II);
(b) L₁, L₂, L₃ and L₄ represent ligands with donor atoms independently selected from N, C, O, S, Se, P and As;
(c) the dashed lines represent that the covalent linkages between neighboring ligands may exist or may not exist;
(d) n+/− represents the number of positive charges or negative charges carried by the metal complexes, and n is selected from 0, 1, 2, 3, 4, 5 and 6.

Suitable small-molecule components also include d¹⁰ metal complexes of a trigonal-planar configuration with monodentate, bidentate or tridentate ligands, represented by the following general formula,

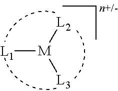

wherein:
(a) M is Cu(I), Ag(I), Au(I), Ni(0), Pd(0), Pt(0), Zn(II), Cd(II) or Hg(II);
(b) L₁, L₂, and L₃ represent ligands with donor atoms independently selected from N, C, O, S, Se, P and As;
(c) the dashed lines indicate that the covalent linkages between neighboring ligands may exist or may not exist;
(d) n+/− represents the number of positive charges or negative charges carried by the metal complexes, and n is selected from 0, 1, 2, 3, 4, 5 and 6.

Additional small-molecule components suitable for living supramolecular polymerization include d¹⁰ metal complexes of a linear configuration, represented by the following general formula,

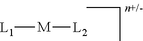

wherein:
(a) M is Cu(I), Ag(I), Au(I), Ni (0), Pd(0), Pt(0), Zn(II), Cd(II) or Hg(II);
(b) Li and L₂ represent ligands with donor atoms independently selected from N, C, O, S, Se, P and As;
(c) n+/− represents the number of positive charges or negative charges carried by the metal complexes, and n is selected from 0, 1, 2, 3, 4, 5 and 6.

In some forms, suitable metal complexes of a planar configuration are palladium(II) 6-phenyl-2,2′-bipyridine complexes defined by formula 1:

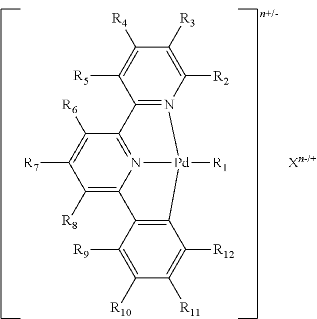

### Formula 1. An Exemplary Palladium(II) 6-phenyl-2,2′-bipyridine Complex

In formula 1, R₁ is selected from, but not limited to, C≡N—R′, pyridine, phosphine, N-heterocyclic carbenes, where R′ is H or substituted or unsubstituted C₁-C₃₀ alkyl, C₂-C₃₀ alkenyl, C₂-C₃₀ alkynyl, C₃-C₃₀ aryl (e.g., phenyl, tolyl, xylyl, and naphthyl), C₃-C₃₀ heteroaryl, C₁-C₃₀ alkoxy, C₃-C₃₀ phenoxy, C₃-C₃₀ aryloxy, C₃-C₃₀ arylthio, C₁-C₃₀ alkylthio, C₂-C₃₀ carbonyl, C₁-C₃₀ carboxyl, amino, amido, polyaryl, which may contain heteroatoms; R₂, R₃, R₄, R₅, R₆, R₇, R₈, R₉, R₁₀, R₁₁ and R₁₂ are, independently, H, C₁-C₃₀ alkyl, C₂-C₃₀ alkenyl, C₂-C₃₀ alkynyl, C₃-C₃₀ aryl or N-substituted amide, e.g., the substitution being C₁-C₃₀ alkyl, which may contain heteroatoms; n+/− represents the number of positive charges or negative charges carried by the metal complexes, and n is selected from 0, 1, 2, 3, 4, 5 and 6; Xⁿ⁻ is an anion, such as but, not limited to, chloride (Cl⁻), nitrate (NO₃⁻), trifluoromethanesulfonate (OTf⁻), hexafluorophosphate (PF₆⁻), perchlorate (ClO₄⁻), tetrafluoroborate (BF₄⁻), and tetraphenylboronate (BPh₄⁻); and Xⁿ⁺ is a cation, such as, but not limited to, Na⁺, K⁺, Ca²⁺, Mg²⁺, bis(triphenylphosphine)iminium (PPN⁺), quaternary ammonium cations, pyridinium cations and phosphonium cations.

In some forms, one or more pyridyl portions of formula 1 can be substituted with other heterocycles.

In some forms, suitable palladium(II) 6-phenyl-2,2′-bipyridine complexes for supramolecular co-assembly have a structure of formula 1 where R₁ is 2,6-dimethylphenyl isocyanide and R₂-R₁₂ are H, as shown by formula 2, i.e., [Pd(C\hat{ }N\hat{ }N)(C≡N-2,6-dimethylphenyl)]X, denoted as Complex 1.

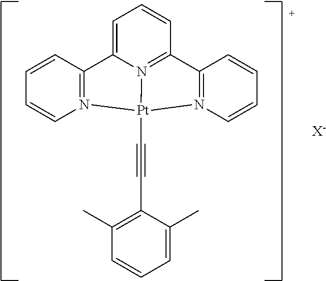

### Formula 2. Chemical Structure of Complex 1, [Pd(C\hat{ }N\hat{ }N)(C≡N-2,6-dimethylphenyl)]X

HC\hat{ }N\hat{ }N=6-phenyl-2,2′-bipyridine; X⁻ is an anion, which is selected from, but not limited to, nitrate (NO₃⁻), trifluoromethanesulfonate (OTf⁻), hexafluorophosphate (PF₆⁻), perchlorate (ClO₄⁻), tetrafluoroborate (BF₄⁻), and tetraphenylboronate (BPh₄⁻).

In some forms, suitable metal complex of a planar configuration are platinum(II) 6-phenyl-2,2′-bipyridine complexes defined by formula 3:

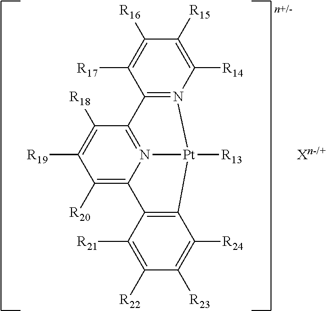

### Formula 3. An Exemplary Platinum(II) 6-phenyl-2,2′-bipyridine Complex

In formula 3, R₁₃ is selected from, but not limited to, C≡N—R′, pyridine, phosphine, N-heterocyclic carbenes, where R′ is H or substituted or unsubstituted C₁-C₃₀ alkyl, C₂-C₃₀ alkenyl, C₂-C₃₀ alkynyl, C₃-C₃₀ aryl (e.g., phenyl, tolyl, xylyl, and naphthyl), C₃-C₃₀ heteroaryl, C₁-C₃₀ alkoxy, C₃-C₃₀ phenoxy, C₃-C₃₀ aryloxy, C₃-C₃₀ arylthio, C₁-C₃₀ alkylthio, C₂-C₃₀ carbonyl, C₁-C₃₀ carboxyl, amino, amido, polyaryl, which may contain heteroatoms; R₁₄, R₁₅, R₁₆, R₁₇, R₁₈, R₁₉, R₂₀, R₂₁, R₂₂, R₂₃ and R₂₄ are, independently, H, C₁-C₃₀ alkyl, C₂-C₃₀ alkenyl, C₂-C₃₀ alkynyl, C₃-C₃₀ aryl or N-substituted amide, e.g., the substitution being C₁-C₃₀ alkyl, which may contain heteroatoms; n+/− represents the number of positive charges or negative charges carried by the metal complexes, and n is selected from 0, 1, 2, 3, 4, 5 and 6; Xⁿ is an anion, such as, but not limited to, chloride (Cl⁻), nitrate (NO₃⁻), trifluoromethanesulfonate (OTf⁻), hexafluorophosphate (PF₆⁻), perchlorate (ClO₄⁻), tetrafluoroborate (BF₄⁻), and tetraphenylboronate (BPh₄⁻); and Xⁿ⁺ is a cation, such as, but not limited to, Na⁺, K⁺, Ca²⁺, Mg²⁺, bis(triphenylphosphine)iminium (PPN⁺), quaternary ammonium cations, pyridinium cations and phosphonium cations.

In some forms, one or more pyridyl portions of formula 3 can be substituted with other heterocycles.

In some forms, suitable platinum(II) 6-phenyl-2,2′-bipyridine complex for supramolecular co-assembly have a structure of formula 3 where R₁₃ is 2,6-dimethylphenyl isocyanide and R₁₄-R₂₄ are H, as shown by formula 4, i.e., [Pt(C\hat{ }N\hat{ }N)(C≡N-2,6-dimethylphenyl)]X, denoted as Complex 2.

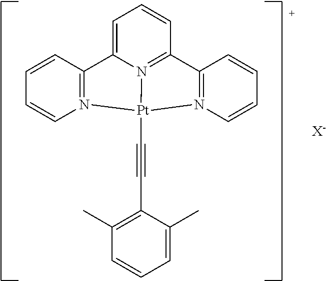

Formula 4. Chemical structure of Complex 2, [Pt(C\hat{ }N\hat{ }N)(C≡N-2,6-dimethylphenyl)]X. HC\hat{ }N\hat{ }N=6-phenyl-2,2′-bipyridine; X⁻ is an anion, which is selected from, but not limited to, nitrate (NO₃⁻), trifluoromethanesulfonate (OTf⁻), hexafluorophosphate (PF₆⁻), perchlorate (ClO₄⁻), tetrafluoroborate (BF₄⁻), and tetraphenylboronate (BPh₄⁻).

In some forms, suitable metal complexes of a planar configuration are platinum (II) 1,3-bis(2′-pyridyl)benzene complexes defined by formula 5:

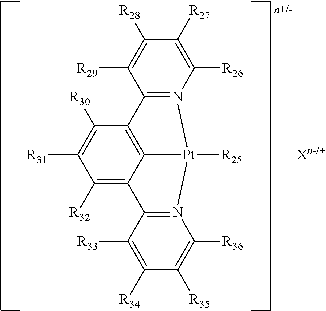

### Formula 5. An Exemplary Platinum(II) 1,3-bis(2′-pyridyl)benzene Complex

In formula 5, R₂₅ is selected from, but not limited to, C≡N—R′, pyridine, phosphine, N-heterocyclic carbenes, where R′ is H or substituted or unsubstituted C₁-C₃₀ alkyl, C₂-C₃₀ alkenyl, C₂-C₃₀ alkynyl, C₃-C₃₀ aryl (e.g., phenyl, tolyl, xylyl, and naphthyl), C₃-C₃₀ heteroaryl, C₁-C₃₀ alkoxy, C₃-C₃₀ phenoxy, C₃-C₃₀ aryloxy, C₃-C₃₀ arylthio, C₁-C₃₀ alkylthio, C₂-C₃₀ carbonyl, C₁-C₃₀ carboxyl, amino, amido, polyaryl, which may contain heteroatoms; R₂₆, R₂₇, R₂₈, R₂₉, R₃₀, R₃₁, R₃₂, R₃₃, R₃₄, R₃₅ and R₃₆ are, independently, H, C₁-C₃₀ alkyl, C₂-C₃₀ alkenyl, C₂-C₃₀ alkynyl, C₃-C₃₀ aryl or N-substituted amide, e.g., the substitution being C₁-C₃₀ alkyl, which may contain heteroatoms; n+/− represents the number of positive charges or negative charges carried by the metal complexes, and n is selected from 0, 1, 2, 3, 4, 5 and 6; Xⁿ is an anion, such as but, not limited to, chloride (Cl⁻), nitrate (NO₃⁻), trifluoromethanesulfonate (OTf⁻), hexafluorophosphate (PF₆⁻), perchlorate (ClO₄), tetrafluoroborate (BF₄⁻), and tetraphenylboronate (BPh₄⁻); and Xⁿ⁺ is a cation, such as, but not limited to, Na⁺, K⁺, Ca²⁺, Mg²⁺, bis(triphenylphosphine)iminium (PPN⁺), quaternary ammonium cations, pyridinium cations and phosphonium cations.

In some forms, the one or more pyridyl portions of formula 5 can be substituted with other heterocycles.

In some forms, suitable platinum(II) 1,3-bis(2′-pyridyl)benzene complexes for supramolecular co-assembly have a structure of formula 5 where R₂₅ is 2,6-dimethylphenyl isocyanide and R₂₆-R₃₆ are H, as shown by formula 6, i.e., [Pt(N\hat{ }C\hat{ }N)(C≡N-2,6-dimethylphenyl)]X, denoted as Complex 3.

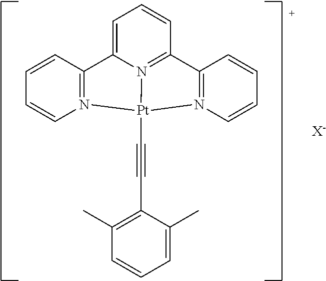

Formula 6. Chemical structure of Complex 3, [Pt(N\hat{ }C\hat{ }N)(C≡N-2,6-dimethylphenyl)]X. N\hat{ }CH\hat{ }N=1,3-bis(2′-pyridyl)benzene; X⁻ is an anion, which is selected from, but not limited to, nitrate (NO₃⁻), trifluoromethanesulfonate (OTf⁻), hexafluorophosphate (PF₆⁻), perchlorate (ClO₄⁻), tetrafluoroborate (BF₄⁻), and tetraphenylboronate (BPh₄⁻).

In some forms, suitable metal complexes of a planar configuration are an alkynylplatinum(II) terpyridine complex defined by formula 7:

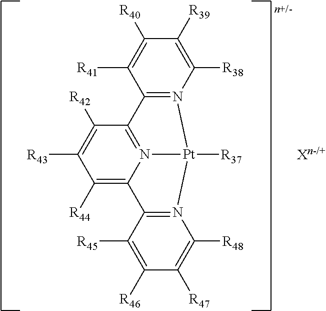

Formula 7. An exemplary alkynylplatinum(II) terpyridine complex.

In formula 7, R₃₇ is selected from, but not limited to, C≡C—R′, C≡N—R′, pyridine, phosphine, N-heterocyclic carbenes, where R′ is H or substituted or unsubstituted C₁-C₃₀ alkyl, C₂-C₃₀ alkenyl, C₂-C₃₀ alkynyl, C₃-C₃₀ aryl (e.g., phenyl, tolyl, xylyl, and naphthyl), C₃-C₃₀ heteroaryl, C₁-C₃₀ alkoxy, C₃-C₃₀ phenoxy, C₃-C₃₀ aryloxy, C₃-C₃₀ arylthio, C₁-C₃₀ alkylthio, C₂-C₃₀ carbonyl, C₁-C₃₀ carboxyl, amino, amido, polyaryl, which may contain heteroatoms; m is an integer between 1 and 20, e.g., m=1, 2, 3, 4, 5; R₃₈, R₃₉, R₄₀, R₄₁, R₄₂, R₄₃, R₄₄, R₄₅, R₄₆, R₄₇ and R₄₈ are, independently, H, C₁-C₃₀ alkyl, C₂-C₃₀ alkenyl, C₂-C₃₀ alkynyl, C₃-C₃₀ aryl or N-substituted amide, e.g., the substitution being C₁-C₃₀ alkyl, which may contain heteroatoms; n+/− represents the number of positive charges or negative charges carried by the metal complexes, and n is selected from 0, 1, 2, 3, 4, 5 and 6; Xⁿ is an anion, such as, but not limited to, chloride (Cl⁻), nitrate (NO₃⁻), trifluoromethanesulfonate (OTf⁻), hexafluorophosphate (PF₆⁻), perchlorate (ClO₄), tetrafluoroborate (BF₄⁻), and tetraphenylboronate (BPh₄⁻); and Xⁿ⁺ is a cation, such as, but not limited to, Na⁺, K⁺, Ca²⁺, Mg²⁺, bis(triphenylphosphine)iminium (PPN⁺), quaternary ammonium cations, pyridinium cations and phosphonium cations.

In some forms, one or more pyridine portions of formula 7 can be substituted with other heterocycles.

In some forms, suitable platinum(II) complexes for supramolecular co-assembly have a structure of formula 7 where R₃₇ is 2,6-dimethylphenyl, m is 1, and R₃₈-R₄₈ are H, as shown by formula 8, i.e., [Pt(tpy)(C≡C-2,6-dimethylphenyl)]X, denoted as Complex 4.

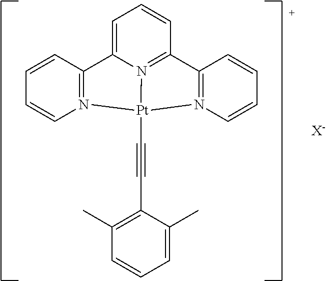

Formula 8. Chemical structure of Complex 4, [Pt(tpy)(C≡C-2,6-dimethylphenyl)]X. tpy=2,2′:6′,2″-terpyridine; X⁻ is an anion, which is selected from, but not limited to, nitrate (NO₃⁻), trifluoromethanesulfonate (OTf⁻), hexafluorophosphate (PF₆⁻), perchlorate (ClO₄⁻), tetrafluoroborate (BF₄⁻), and tetraphenylboronate (BPh₄⁻).

In some forms, suitable metal complexes of a planar configuration are planar configurations of rhodium(I) complexes. For example, an exemplary rhodium(I) complex shown by formula 9.

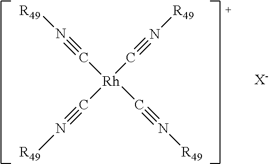

### Formula 9. An Exemplary tetrakis(isocyano)rhodium(I) Complex

In formula 9, R₄₉ is substituted or unsubstituted C₁-C₃₀ alkyl, C₂-C₃₀ alkenyl, C₂-C₃₀ alkynyl, C₃-C₃₀ aryl (e.g., phenyl, tolyl, xylyl, and naphthyl), C₃-C₃₀ heteroaryl, C₁-C₃₀ alkoxy, C₃-C₃₀ phenoxy, C₃-C₃₀ aryloxy, C₃-C₃₀ arylthio, C₁-C₃₀ alkylthio, C₂-C₃₀ carbonyl, C₁-C₃₀ carboxyl, amino, amido, polyaryl, which may contain heteroatoms.

### 2. Organic Molecules

In addition, suitable small-molecule components for supramolecular co-assembly include planar organic molecules that are positively charged, negatively charged or charge-neutral. Suitable planar molecules can have one or more aryls, heteroaryls or polyaryls in a planar configuration, one or more atoms (including heteroatoms) supporting hydrogen bonding, or a combination of both.

An exemplary planar organic molecule for supramolecular co-assembly is shown by formula 10; and an exemplary planar organic molecule for supramolecular co-assembly is shown by formula 11, denoted as Organic Molecule 1.

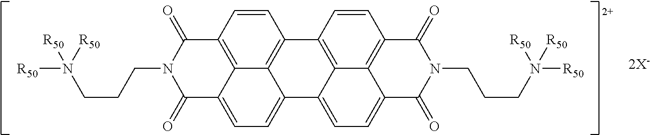

### Formula 10. An Exemplary Organic Molecule

In formula 10, R₅₀ is H or substituted or unsubstituted C₁-C₃₀ alkyl, C₂-C₃₀ alkenyl, C₂-C₃₀ alkynyl, C₃-C₃₀ aryl (e.g., phenyl, tolyl, xylyl, and naphthyl), C₃-C₃₀ heteroaryl, C₁-C₃₀ alkoxy, C₃-C₃₀ phenoxy, C₃-C₃₀ aryloxy, C₃-C₃₀ arylthio, C₁-C₃₀ alkylthio, C₂-C₃₀ carbonyl, C₁-C₃₀ carboxyl, amino, amido, polyaryl, which may contain heteroatoms.

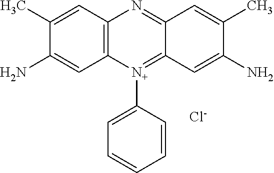 [SMILES: Cc1cc2nc3cc(C)c(N)cc3[n+](-c3ccccc3)c2cc1N ; [Cl-]]

### Formula 11. Chemical Structure of Organic Molecule 1

### B. Solvophilic Polymers

A polymer component, which can non-covalently (e.g., electrostatically) interact with the small-molecule components in the preformed supramolecular polymers, is used in the supramolecular co-assembly. Generally, a solvophilic polymer is used for assisting and co-assembling with the supramolecular polymers containing planar small molecules. In some embodiment, the polymer contains one or more segments or blocks that can be deprotonated or protonated to become ions and interact electrostatically with the planar small molecules. In some embodiments, supramolecular polymers assembled from the disclosed small-molecule components and the polymer component form a core-shell structure. In such structures, for example, a charged portion of the polymer component interacts and resides with the small-molecule components as the core and a neutral and solvophilic portion of the polymer component is presented as a shell. In an aqueous medium, for example, the neutral and solvophilic portion of the polymer can be, for example, one or more polyalkylene oxide portions (e.g., polyethylene glycol (PEG)), one or more polypropylene glycol portions, or both. In some embodiments, the polyalkylene oxide portion of the polymer has a weight average molecular weight of from about 1 kDa to about 21 kDa (e.g., from about 1 kDa to about 3 kDa, e.g., about 2 kDa, or from about 2 kDa to about 5 kDa, e.g., about 3.5 kDa, or from about 4 kDa to about 6 kDa, e.g., about 5 kDa). In some embodiments, the average weight percentage of the polyalkylene oxide portion of the polymer is from about 20% to about 90%, or from about 30% to about 80%, or from about 40% to about 60%.

Examples of suitable polymer components include diblock copolymers, triblock copolymers and multi-block copolymers, wherein at least one of the blocks is solvophilic or hydrophilic and at least one of the blocks can bind the small-molecule component through non-covalent interactions comprising electrostatic interactions, hydrogen-bonding interactions, solvophobic-solvophobic (or hydrophobic-hydrophobic) interactions and π-π interactions, and wherein each of the blocks are independently selected from, but are not limited to, one or more of poly(acrylic acid), poly(acrylate), poly(methacrylic acid), poly (methacrylate), poly(acrylamide), poly(methacrylamide), poly(oxide), polyphosphite, polyphosphonate, polyphosphate, polyphosphoramidate, poly(carbonate), poly(ester), poly(anhydride), poly(urethane), poly(diene), poly(acetylene), poly(alkene), poly(vinyl ether), poly(vinyl alcohol), poly(vinyl ketone), poly(vinyl halide), poly(vinyl nitrite), poly (vinyl ester), poly(styrene), poly(vinyl pyridine), quaternized poly(vinyl pyridine), polyethylenimine, poly(lysine), polyphosphonium, polysulfonium, poly(amide), poly(amino acid), poly(lactic acid), poly(saccharide), DNA, RNA, poly(aromatic sulfonate), quaternized poly(arylamine), polyammonium, polyvinylpyrrolidone, poly(ethylene glycol), poly(alkylaminoacrylate), and their derivatives.

Exemplary polymer components further include amphiphilic polymeric surfactants selected from, but not limited to, one or more of poly(acrylic acid), poly(acrylate), poly(methacrylic acid), poly(methacrylate), poly(acrylamide), poly(methacrylamide), poly(oxide), polyphosphite, polyphosphonate, polyphosphate, polyphosphoramidate, poly(carbonate), poly(ester), poly(anhydride), poly(urethane), poly(diene), poly(acetylene), poly(alkene), poly(vinyl ether), poly(vinyl alcohol), poly(vinyl ketone), poly(vinyl halide), poly(vinyl nitrite), poly(vinyl ester), poly(styrene), poly(vinyl pyridine), quaternized poly(vinyl pyridine), polyethylenimine, poly(lysine), polyphosphonium, polysulfonium, poly(amide), poly(amino acid), poly(lactic acid), poly(saccharide), DNA, RNA, poly(aromatic sulfonate), quaternized poly(arylamine), polyammonium, polyvinylpyrrolidone, poly(ethylene glycol), poly(alkylaminoacrylate), their copolymers and their solvophobically (or hydrophobically) modified derivatives.

### C. Medium (e.g., Solvents and pH)

A suitable solvent for the supramolecular co-assembly disclosed herein is one where the planar and/or small molecules do not dissolve or have poor solubility; while the polymers that can interact with the planar small molecule may be solubilized therein. The solvent permits one or more non-covalent interactions, e.g., but not limited to, metal-metal interactions, rr-xr interactions, hydrogen-bonding interactions, and solvophobic-solvophobic (or hydrophobic-hydrophobic) interactions, for the assembly of planar small molecules. Solvent is selected such that the small-molecule component with planar or linear geometry is solvophobic and exhibits a strong interaction to permit the supramolecular co-assembly of the small-molecule component in the presence of the solvophilic polymer component.

The solvent can be adjusted for different pH such that one or more portions or blocks of the polymer may be deprotonated or protonated, dependent on the pKₐ of polymer, to become available for at least electrostatic interactions with the planar small molecules. Suitable pH can be about pH 1, 2, 3, 4, 5, 6, 7, 8, 9, 10, 11, 12, 13.

An exemplary suitable medium is an aqueous solution of a defined pH to support non-covalent interactions between the polymer and the planar small molecules, e.g., electrostatic interactions.

### D. Architectures and Properties of Formed Supramolecular Nanostructures

The disclosed supramolecular nanostructures generally form, but are not limited to, heterostructures containing alternate rigid rod-like segments and flexible segments with fiber-like, belt-like, or loop-like structures, or flexible ribbon-like, belt-like, loop-like block co-micelles, where the width can be several or a few hundred nanometers and the length can be tens of nanometers to one micron or even several tens or hundreds of microns. In some forms, the flexible segments or co-micelles formed can exhibit a core-shell structure; the nanosized core comprising the small molecules is packed in a highly ordered manner, and the shell composes of polymers. In some forms, the supramolecular nanostructures can exhibit one-dimensional morphologies such as, but are not limited to, alternate nanorod and nanowires/nanofibers/nanobelts. In some forms, the supramolecular nanostructures can display three-dimensional loop-like structures or branched multi-segments. The rigidity of the flexible segments is regulated by the internal attractions within the supramolecular polymers. The morphologies can also be modulated by the steric repulsion between the polymer shell chains. Large steric repulsion results in morphologies with a high curvature (such as nanofibers), whereas small steric repulsion leads to morphologies with a low curvature (such as nanobelts). The overall lengths of the supramolecular nanostructures can be controlled by the initial concentration of the small-molecule components during the preparation of precursors or the degree of aggregation during the hierarchical self-assembly of the preformed heterostructures. The relative lengths of the rigid and flexible segments can be tuned by the feed ratio of the small molecules to the polymers; large feed ratio leads to long flexible segments. The diameters of the supramolecular polymers can be controlled by the structural parameters of the polymers and can also be affected by the strength of the non-covalent interactions between the polymers and the small molecules.

After the formation of the supramolecular heterostructures, further addition of polymers leads to a decrease of the rigid segments and an increase of the flexible segments. In some forms, the flexible segments of the co-assembled supramolecular heterostructures remain active and thus can undergo hierarchical self-assembly by end-to-end connection, resulting in multi-segmented heterostructures. When supramolecular copolymers are used as the precursors instead of supramolecular homopolymers for co-assembly with the polymer components, the segmented compositions of supramolecular heterostructures as well as the multi-segmented heterostructures can be further enriched. In some forms, the composition of the flexible segments on the heterostructures can also be enriched by selectively co-assembling with other kinds of small molecules or guest molecules or ions. Unlike existing techniques of living supramolecular polymerizations toward construction of heterostructures where each step for segment formation is based on self-assembly of only one component, i.e., monomer, the disclosed supramolecular co-assembly strategy is based on at least two distinct components of different chemical structures.

### III. Methods of Making and Reagents Therefor

A two-step procedure is employed to realize the supramolecular co-assembly toward supramolecular nanostructures with spatially distinct features. In the first step, one or more small-molecule components supporting non-covalent supramolecular polymerization are used to prepare supramolecular polymers/copolymers as precursors. In the second step, the preformed supramolecular polymers/copolymers and one or more polymer components are mixed and incubated in a suitable medium, generally solvophobic for the small-molecule components and solvophilic for the polymer component, for a period of time (e.g., but not limited to, about 1 hour, a few hours, 1 day, 2 days, or longer) for co-assembly. In some embodiments, the molar ratio of the small molecules to the polymer is from about 0.005:1 to about 50:1 (e.g., about 0.01:1 to about 1:1). In some embodiments, the molar ratio of the small molecules to the polymer can be greater than 1:1, if the concentration and molecular weight of the polymer is effective to support the assembly of monomeric small molecules.

Architectures of supramolecular nanostructures with various morphologies can be obtained by tuning the chemical compositions of the small-molecule component and the polymer component (e.g., concentrations, relative concentrations, chemical compositions and structural parameters), solvent compositions of the systems, and the extent of metal-metal, π-π interactions, hydrogen bonding, and other non-covalent interactions between the building blocks.

### IV. Methods of Using

The disclosed functional supramolecular nanostructures can have various compositions, controlled dimensions, and different architectures. The supramolecular nanostructures can be soluble in those solvents where small-molecule components are solvophobic and polymer components are solvophilic. They can be water-soluble, nanosized with controlled diameters and lengths, and some with visible, red or near-infrared emission properties. These luminescent nanomaterials can find application in bioimaging, medical imaging, chemical and biological sensing. Compared to the monomeric platinum(II) complexes, the supramolecular polymers have more absorption in the visible region and show much stronger emission in the red or near-infrared region. Luminescence and excited-state properties can be associated with metal complexes of d⁸-d⁸, as well as d¹⁰-d¹⁰ interaction (Yam V W W, et al., J. Am. Chem. Soc., 124, 6506 (2002); Yam V W W, et al., Chem. Eur. J., 11, 4535 (2005); Yao L Y, et al., J. Am. Chem. Soc., 136, 10801 (2014); Chan M H Y, et al., J Am. Chem. Soc., 144, 22805 (2022)). Short metal-metal distances are generally found to be associated with these complexes.

Some of the supramolecular nanostructures formed have charge transport properties, which can be used to fabricate organic semiconductors, organic conductors or organic field-effect transistors. These supramolecular nanostructures can also serve as precursors for aligned metal nanoparticles or nanowires.

This disclosure allows supramolecular co-assembly of various small-molecule components such as metal complexes. Some metal complexes can be used as bioprobes, chemosensors, diagnostics, bioimaging and biolabeling agents, and therapeutic drugs. The supramolecular co-assembly of these metal complexes of therapeutic properties can be considered as a drug-loading or drug-encapsulation process. The two-component supramolecular nanostructures of these metal complexes of therapeutic properties can exhibit excellent release properties and can find application in the field of therapeutic drugs.

It is to be understood that the disclosed method and compositions are not limited to specific synthetic methods, specific analytical techniques, or to particular reagents unless otherwise specified, and, as such, may vary. It is also to be understood that the terminology used herein is for the purpose of describing particular embodiments only and is not intended to be limiting.

The methods, compounds, and compositions herein described are further illustrated in the following examples, which are provided by way of illustration and are not intended to be limiting. It will be appreciated that variations in proportions and alternatives in elements of the components shown will be apparent to those skilled in the art and are within the scope of disclosed forms. All parts or amounts, unless otherwise specified, are by weight.

### EXAMPLES

### Example 1. Generation of Supramolecular Nanostructures

### Materials and Methods

Complex 1 was synthesized as described in Angew. Chem. Int. Ed 57, 3089 (2018); Complexes 2 and 3 were synthesized as described in Organometallics 21, 226 (2002); and Angew. Chem. Int. Ed 47, 9895 (2008); and Angew. Chem. Int. Ed 48, 7621 (2009); and Organometallics 32, 350 (2013); Complex 4 was synthesized as Yam V W W and coworkers, Organometallics, 20, 4476 (2001); J. Am. Chem. Soc. 124, 6506 (2002); and ChemistryOpen 3, 172 (2014).

Organic molecule 1 was synthesized as described in Angew. Chem. Int. Ed 49, 1485 (2010). Organic molecule 2 was purchased from Sigma-Aldrich.

Poly(ethylene glycol)-b-poly(tert-butyl acrylate) (PEG-b-PtBA) diblock copolymer was synthesized via atom transfer radical polymerization (Macromolecules 33, 4039 (2000)). The macro-initiator PEG-Br was synthesized as described in Macromolecules 31, 538 (1998). For the polymerization of tBA, a degassed mixture of PEG-Br, CuBr, and tetrahydrofuran and a degassed mixture of PMDETA and tBA were mixed (degassed via nitrogen bubbling). The molar ratio of PEG-Br:CuBr:PMDETA was 1:1:1, and the degree of polymerization of PtBA was controlled by the feed ratio of tBA:PEG-Br and/or polymerization time. The polymerization was conducted at 80° C. in an oil bath and finally quenched in an ice bath. The copper complex in the reaction mixture was removed by passing the reaction mixture through neutral Al₂O₃ column using dichloromethane and/or chloroform as an eluent.

To prepare poly(ethylene glycol)-b-poly(acrylic acid) (PEG-b-PAA), PEG-b-PtBA was first dissolved in dichloromethane, and then trifluoroacetic acid was added into the solution to selectively hydrolyze the tert-butyl ester groups. After hydrolysis for 4-8 hours, the reaction mixture was evaporated under reduced pressure to dryness. The obtained PEG-b-PAA was purified by four cycles of dissolution in methanol/precipitation in hexane.

UV-Vis absorption spectra were recorded on a Cary 50 (Varian) spectrophotometer with a Xenon flash lamp. Steady-state emission spectra were recorded using a Spex Fluorolog-3 Model FL3-211 fluorescence spectrofluorometer equipped with a R2658P PMT detector. Quartz cuvettes with 10-mm path length were used for UV-Vis, emission and circular dichroism measurements unless otherwise indicated. Transmission electron microscopy (TEM) experiments were performed on Philips CM100 with an accelerating voltage of 100 kV. TEM images were captured by Philips CM100 unless otherwise indicated. Energy dispersive X-ray analysis (EDX) and selected area electron diffraction (SAED) experiments were carried out on FEI Tecnai G2 20 Scanning TEM. Scanning electron microscopy (SEM) experiments were performed on a MAIA3 SEM operating at 2.0 kV. Atomic force microscopy (AFM) images were collected on an Asylum MFP3D Atomic Force Microscope with an ARC2 SPM controller under constant temperature and atmospheric pressure. The elemental mapping results were collected by using thermo Scientific Talos F200X STEM.

### Results

The following compositions of supramolecular nanostructures were prepared. The results in Table 1 serve to illustrate one of the many examples of the supramolecular co-assembly disclosed in the present invention and should not be taken as a limiting case of the reagents and conditions used or the dimensions and morphologies observed.

TABLE 1
Exemplary agents and concentrations to
prepare supramolecular nanostructures.
Exemplary agents and concentrations to prepare supramolecular
Nanostructures with spatially distinct features

| | Small- | | | Morphology of |
|---|---|---|---|---|
| Entry | molecular | Polymer | | the |
| no. | component | component | Media | nanostructures |
| 1 | Complex 1 | PEG₄₅-b- | Aqueous | Tri-block with a |
| | (X⁻ = PF₆⁻) | PAA₄₃ | Incubation for | rod-coil-rod |
| | (0.40 mM) | (1.0 mM | 1 day | topology |
| | | carboxylic | | |
| | | acid) | | |
| 2 | Complex 1 | PEG₄₅-b- | Aqueous | Penta-block |
| | (X⁻ = PF₆⁻) | PAA₄₃ | Incubation for | with a coil-rod- |
| | (0.2 mM) | (0.5 mM | 1 day | coil-rod-coil |
| | | carboxylic | | topology |
| | | acid) | | |
| 3 | Complex 1 | PEG₄₅-b- | Aqueous | Penta-block |
| | (X⁻ = PF₆⁻) | PAA₄₃ | Incubation for | with a coil-rod- |
| | (0.2 mM) | (1.0 mM | 1 day | coil-rod-coil |
| | | carboxylic | | topology |
| | | acid) | | |
| 4 | Complex 1 | PEG₄₅-b- | Aqueous | Loops |
| | (X⁻ = PF₆⁻) | PAA₄₃ | Incubation for | |
| | (0.1 mM) | (0.83 mM | 1 day | |
| | | carboxylic | | |
| | | acid) | | |
| 5 | Complex 1 | PEG₄₅-b- | Aqueous | Heterostructure |
| | (X⁻ = PF₆⁻) | PAA₄₃ | Incubation for | with a rod-loop |
| | (0.15 mM) | (1.08 mM | 1 day | topology |
| | | carboxylic | | |
| | | acid) | | |
| 6 | Complex 1 | PEG₄₅-b- | Aqueous | Linear multi- |
| | (X⁻ = PF₆⁻) | PAA₄₃ | Incubation for | segments |
| | (0.3 mM) | (1.5 mM | 1 day | |
| | | carboxylic | | |
| | | acid) | | |
| 7 | Complex 1 | PEG₄₅-b- | Aqueous | Branched multi- |
| | (X⁻ = PF₆⁻) | PAA₄₃ | Incubation for | segments |
| | (0.3 mM) | (3.0 mM | 1 day | |
| | | carboxylic | | |
| | | acid) | | |
| 8 | Complex 1 | PEG₄₅-b- | Aqueous | Penta-block |
| | (X⁻= PF₆⁻) | PAA₆₀ | Incubation for | with a coil-rod- |
| | (0.12 mM) | (1.08 mM | 10 min | coil-rod-coil |
| | | carboxylic | | topology |
| | | acid) | | |
| 9 | Complex 1 | PEG₄₅-b- | Aqueous | Penta-block |
| | (X⁻ = PF₆⁻) | PAA₁₀₀ | Incubation for | with a coil-rod- |
| | (0.12 mM) | (1.08 mM | 10 min | coil-rod-coil |
| | | carboxylic | | topology |
| | | acid) | | |
| 10 | Complex 1 | PEG₁₁₄-b- | Aqueous | Penta-block |
| | (X⁻ = PF₆⁻) | PAA₆₅ | Incubation for | with a coil-rod- |
| | (0.12 mM) | (1.08 mM | 10 min | coil-rod-coil |
| | | carboxylic | | topology |
| | | acid) | | |
| 11 | Complex 2 | PEG₄₅-b- | Aqueous | Penta-block |
| | (X⁻ = PF₆⁻) | PAA₅₀ | Incubation for | with a coil-rod- |
| | (0.15 mM) | (0.6 mM | 1 day | coil-rod-coil |
| | | carboxylic | | topology |
| | | acid) | | |
| 12 | Complex 4 | PEG₄₅-b- | Aqueous | Penta-block |
| | (X⁻ = PF₆⁻) | PAA₅₀ | Incubation for | with a coil-rod- |
| | (0.15 mM) | (0.6 mM | 1 day | coil-rod-coil |
| | | carboxylic | | topology |
| | | acid) | | |
| 13 | Complex 3 | PEG₄₅-b- | Aqueous | Tri-block with a |
| | (X⁻ = PF₆⁻) | PAA₅₀ | Incubation for | coil-rod-coil |
| | (0.15 mM) | (0.6 mM | 10 min | topology |
| | | carboxylic | | |
| | | acid) | | |
| 14 | Complex 1 | PEG₄₅-b- | Aqueous | Tri-block with a |
| | (X⁻ = PF₆⁻) | PAA₄₃ | The | coil-rod-coil |
| | (0.15 mM) | (0.6 mM | supramolecular | topology |
| | | carboxylic | polymers were | |
| | | acid) | treated with | |
| | | | sonication | |
| | | | before co- | |
| | | | assembly; | |
| | | | Incubation for | |
| | | | 5 min | |
| 15 | Complex 4 | PEG₄₅-b- | Aqueous | Tri-block with a |
| | (X⁻ = PF₆⁻) | PAA₅₀ | The | coil-rod-coil |
| | (0.15 mM) | (0.6 mM | supramolecular | topology |
| | | carboxylic | polymers were | |
| | | acid) | treated with | |
| | | | sonication | |
| | | | before co- | |
| | | | assembly; | |
| | | | Incubation for | |
| | | | 1 hour | |
| 16 | Complex 4 | PEG₄₅-b- | Aqueous | Tri-block with a |
| | (0.15 mM) | PAA₅₀ | The | coil-rod-coil |
| | (X⁻ = | (0.6 mM | supramolecular | topology |
| | ClO₄⁻) | carboxylic | polymers were | |
| | | acid) | treated with | |
| | | | sonication | |
| | | | before co- | |
| | | | assembly; | |
| | | | Incubation for | |
| | | | 1 hour | |
| 17 | Complex 2 | PEG₄₅-b- | Aqueous | Penta-block |
| | (X⁻ = PF₆⁻, | PAA₅₀ | Incubation for | with a rod-coil- |
| | 0.15 mM) | (0.5 mM | 1 day | rod topology |
| | form the | carboxylic | | |
| | central | acid) | | |
| | block; | | | |
| | Complex 1 | | | |
| | (X⁻ = PF₆⁻) | | | |
| | (0.04 mM) | | | |
| | form the | | | |
| | terminal | | | |
| | blocks | | | |
| 18 | Complex 1 | PEG₄₅-b- | Aqueous | Hepta-block |
| | (X⁻ = PF₆⁻, | PAA₄₃ | Incubation for | with a coil-rod- |
| | 0.05 mM) | (0.54 mM | 1 day | coil-rod-coil |
| | form the | carboxylic | | topology |
| | central | acid) | | |
| | block; | | | |
| | Complex 2 | | | |
| | (X⁻ = | | | |
| | ClO₄⁻) | | | |
| | (0.04 mM) | | | |
| | form the | | | |
| | terminal | | | |
| | blocks | | | |
| 19 | Complex 2 | PEG₄₅-b- | Aqueous | Hepta-block |
| | (X⁻ = PF₆⁻, | PAA₅₀ | Incubation for | with a coil-rod- |
| | 0.05 mM) | (0.54 mM | 1 day | coil-rod-coil |
| | form the | carboxylic | | topology |
| | central | acid) | | |
| | block; | | | |
| | Complex 1 | | | |
| | (X⁻ = PF₆⁻) | | | |
| | (0.04 mM) | | | |
| | form the | | | |
| | terminal | | | |
| | blocks | | | |
| 20 | Complex 1 | PEG₄₅-b- | Aqueous | Multi- |
| | (X⁻ = PF₆⁻, | PAA₄₃ | Incubation for | segmented |
| | 0.15 mM) | (1.0 mM | 1 day | heterostructures |
| | form the | carboxylic | | |
| | central | acid) | | |
| | block; | | | |
| | Complex 2 | | | |
| | (X⁻ = | | | |
| | ClO₄⁻) | | | |
| | (0.04 mM) | | | |
| | form the | | | |
| | terminal | | | |
| | blocks | | | |
| 21 | Complex 2 | PEG₄₅-b- | Aqueous | Multi- |
| | (X⁻ = PF₆⁻, | PAA₅₀ | Incubation for | segmented |
| | 0.15 mM) | (1.0 mM | 1 day | heterostructures |
| | form the | carboxylic | | |
| | central | acid) | | |
| | block; | | | |
| | Complex 1 | | | |
| | (X⁻ = PF₆⁻) | | | |
| | (0.04 mM) | | | |
| | form the | | | |
| | terminal | | | |
| | blocks | | | |

### Example 2. Construction of Tri-Block Heterostructures from Supramolecular Co-Assembly of the Two-Component System Involving Complex 1 and PEG₄₅-b-PAA₄₃ (Entry No. 1 in Table 1)

A two-step procedure was adopted for the supramolecular co-assembly of complex 1 and PEG₄₅-b-PAA₄₃ (the subscript represents the degree of polymerization of each block). In the first step, supramolecular polymers of complex 1 were prepared as precursors by mixing the acetonitrile solution of complex 1 and water and then incubating for at least 6 hours. In the second step, the preformed aqueous solution of supramolecular polymers was mixed with methanol solution of PEG₄₅-b-PAA₄₃ to perform the co-assembly. The mixture was incubated for 1 day. The concentrations of small-molecule complex 1 and carboxylic acid in the mixture were 0.4 mM and 1 mM, respectively. The pH value of the mixture was ˜4, where the carboxylic acid groups were partially deprotonated. Polymer component of PEG-b-PAA interacted with small-molecule component of complex 1 via electrostatic interaction.

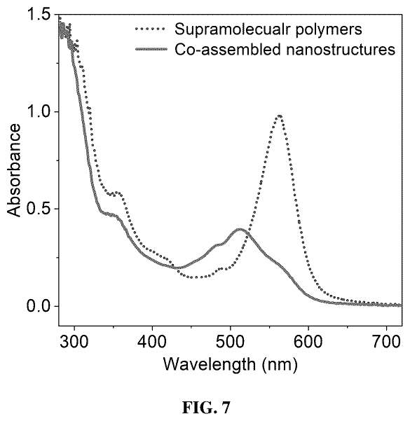

The resulted supramolecular nanostructures obtained are heterostructures with a rod-coil-rod topology (FIG. 9). The middle coil-like segments are formed from co-assembly of block copolymers and complex 1 in the central region of the preformed supramolecular polymers of complex 1. As a control, directed co-assembly of complex 1 and block copolymers of PEG₄₅-b-PAA₄₃ at the same solvent conditions and feed ratios can only form a mixture of nanoaggregates, nanofibers, coil-rod-coil, and/or other kinds of co-assemblies with ill-defined morphologies.

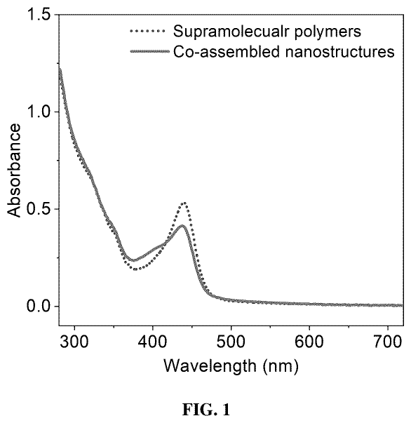

The UV-vis spectrum of supramolecular polymers of complex 1 (precursors) showed an absorbance band at approximately 439 nm (FIG. 1). This absorption band originated from metal-metal-to-ligand charge transfer (MMLCT) transitions in the formed infinite chains of complex 1 during supramolecular polymerization. After co-assembly with the polymer components, the intensity of the absorbance band at 439 nm decreased slightly, which can be attributed to the breakage of original infinite chains of orderly stacked complex 1 into shorter ones or oligomers of complex 1. The steady-state emission spectra were recorded by excitation at the isosbestic wavelength of 415 nm (FIG. 2). The³MMLCT emission bands of both the precursors and co-assemblies appeared at around 495 nm. The decrease of relative emission intensity was also originated from breakage of infinite chains of complex 1 into shorter one.

### Example 3. Construction of Penta-Block Heterostructures from Supramolecular Co-Assembly of the Two-Component System Involving Complex 1 and PEG₄₅-b-PAA₄₃ (Entry Nos. 2 to 4 in Table 1)

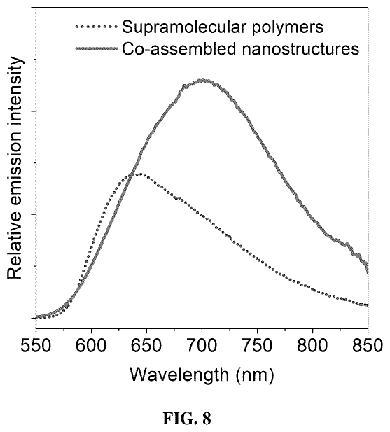

The supramolecular heterostructures were prepared by mixing preformed supramolecular polymers of small-molecule complex 1 with block copolymers of PEG₄₅-b-PAA₄₃ in an aqueous solution, and the mixture was allowed to undergo incubation. By decreasing the concentration of precursors of supramolecular polymers and polymer components, the co-assembly was occurred at the both the central region and the termini of the preformed supramolecular polymers, leading to the formation of penta-block heterostructures with a coil-rod-coil-rod-coil topology. (FIG. 10).

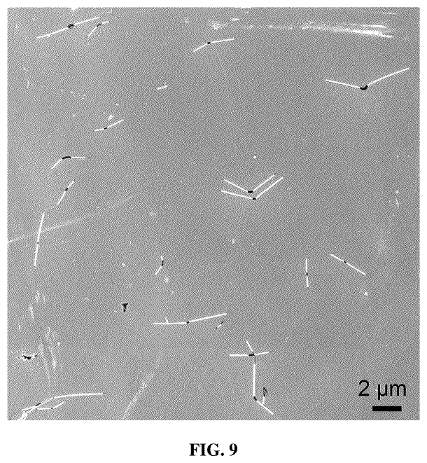

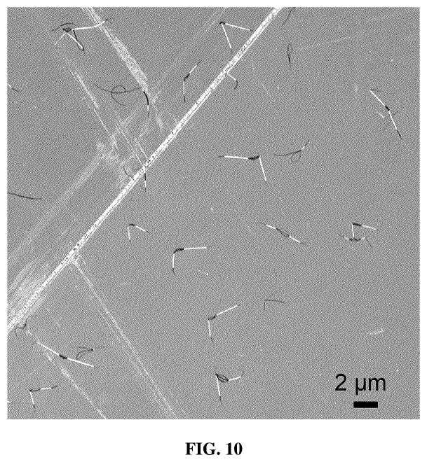

Through increasing the feed ratio of polymer component to the component of complex 1, the relative length of rod-like segments reduced and the length of coil-like segments prolonged (FIG. 11). Further decreasing the concentration of complex 1 and block polymers while increasing the feed ratio led to the formation of loops instead of heterostructures (FIG. 12). This result indicated that the complex 1 in the preformed supramolecular polymers thoroughly undergo co-assembly with the polymer components.

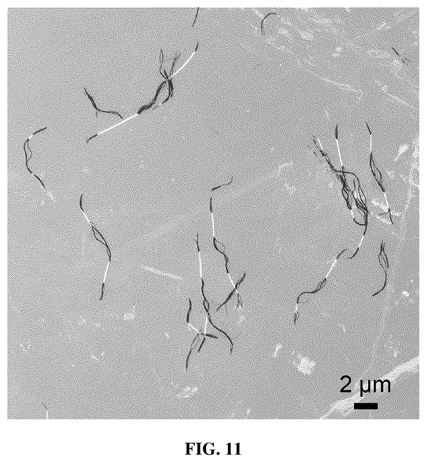

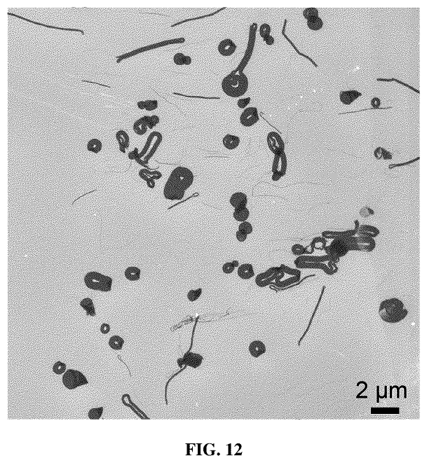

To reveal the stacking arrangement of complex 1 in the rod-like segments and flexible coil-like segments, selected area electron diffraction (SAED) was taken for the rigid and flexible segments. The rigid part of the formed heterostructure showed a series of diffraction spots that corresponded to the closely stacking of complex 1 in the crystalline rod-like segment. The d-spacing of complex 1 in the rigid segment was calculated to be 0.338 nm (FIG. 13). However, SAED pattern of the coil part showed a pair of symmetric diffraction arcs that corresponded to an ordered packing of palladium complexes in the nanofibers with a d-spacing of 0.342 nm (FIG. 14). The diffraction pattern was believed to be attributed to the periodical arrangement of palladium atoms in the rigid and flexible segments. The spacing of ˜0.34 nm for both kinds of segments is characteristic of non-covalent metal-metal and/or π-π interaction. The axis of the metal-metal interaction was perpendicular to the plane of the small-molecule palladium(II) complex, and thus the distance between two neighboring palladium(II) complexes was also about 0.34 nm. These results indicated there were π-π interactions between the palladium(II) complex molecules in both the rigid and flexible segments. Metal-metal interactions and π-π interactions between the small-molecular palladium(II) complexes, together with the non-covalent interactions with the polymer component, were believed to drive the supramolecular co-assembly as well as the formation of nanofibers in the coil segments.

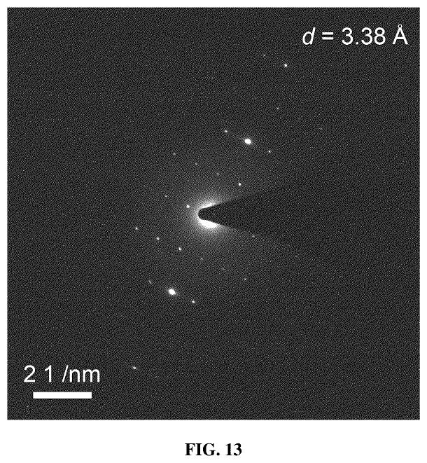

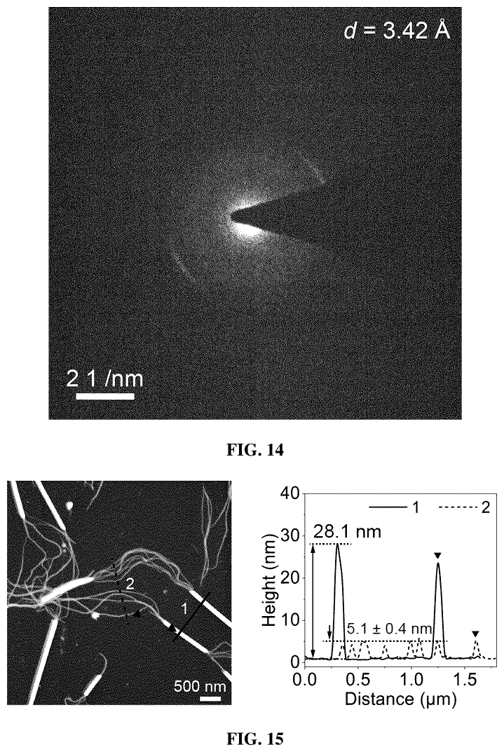

The nanofibers in the coil part of the formed supramolecular heterostructures possessed a core-shell structure with a thickness of ˜5 nm, as revealed by atomic force microscopy (AFM) (FIG. 15). The core was of a “brick-and-mortar” structure formed by complex 1 and PAA, where the complexes were packed into ordered structures in which the flexible PAA polymer chains interacted with the complexes and stabilized the structures. The shell is composed of the PEG chains, which stabilize the nanofiber in aqueous solution and provide the nanofibers with long-term water-solubility. The core-shell structure was further confirmed by the selective-stained TEM experiment (FIG. 16). PEG-coated nanofibers have been demonstrated to exhibit longer circulation time in blood by an order of magnitude than their spherical counterparts (Geng Y, et al., Nat. Nanotechnol., 2, 249 (2007)).

### Example 4. Construction of Rod-Loop Heterostructures from Supramolecular Co-Assembly of the Two-Component System Involving Complex 1 and PEG₄₅-b-PAA₄₃ (Entry No. 5 in Table 1)

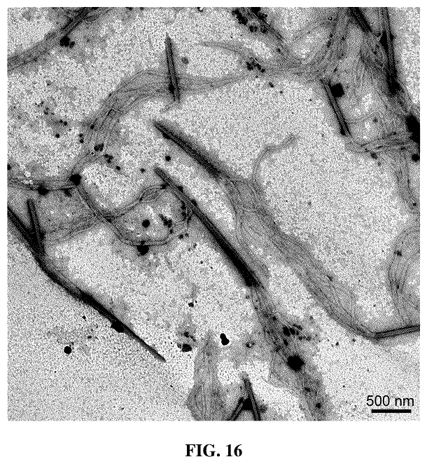

Supramolecular co-assembly of small-molecule complex 1 and PEG₄₅-b-PAA₄₃ was performed by following a two-step procedure in an aqueous solution. In the first step, the supramolecular polymers were prepared as precursors by mixing the acetonitrile solution of complex 1 and water and then incubating for at least 6 hours. The concentration of complex 1 is 0.15 mM. In the second step, the aqueous solution of PEG₄₅-b-PAA₄₃ was added to the solution of supramolecular polymers in a step-by-step manner. The total volume of polymer solution was added to the aqueous solution of supramolecular polymers six times to reach a final concentration of carboxylic acid of 1.08 mM. As a result, the kinetics of supramolecular co-assembly was slowed down and the intermediate rod-coil-rod heterostructures gradually transformed into metastable heterostructures with a rod-loop topology (FIG. 17). The length of the rod segment and the outer diameter of the loop-shaped segment can be tuned by changing the feed ratio.

### Example 5. Construction of Multi-Segmented Heterostructures from Hierarchical Self-Assembly of the Preformed Penta-Block Heterostructures (Entry No. 6 and No. 7 in Table 1)

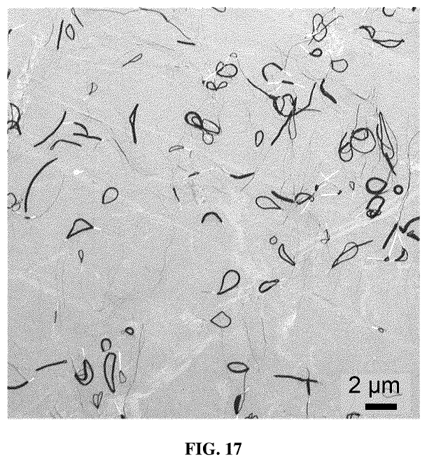

Through increasing the initial concentration of both the precursors of supramolecular polymers and polymer components, as well as the feed ratio of polymer components to complex 1, the preformed penta-block heterostructures with a coil-rod-coil-rod-coil topology can undergo hierarchical self-assembly by connecting their flexible segments. For instance, when the concentrations of complex 1 and carboxylic acid in the mixture are 0.3 mM and 1.5 mM, respectively (Entry no. 6), the preformed coil-rod-coil-rod-coil heterostructures undergo end-to-end connection at their coil termini. As a result, multi-segmented heterostructures containing alternate rigid and flexible segments were formed (FIG. 18). The coil termini of the preformed penta-block heterostructures were composed of both the component of small-molecule complex 1 and polymer component. Similar to the driving forces for the formation of coil-like segments on the heterostructures from co-assembly of the two components, metal-metal interactions and π-π interactions between the small-molecular palladium(II) complexes, together with the non-covalent interaction with the polymer component, were believed to facilitate the end-to-end connection of coil-like termini of the penta-block heterostructures.

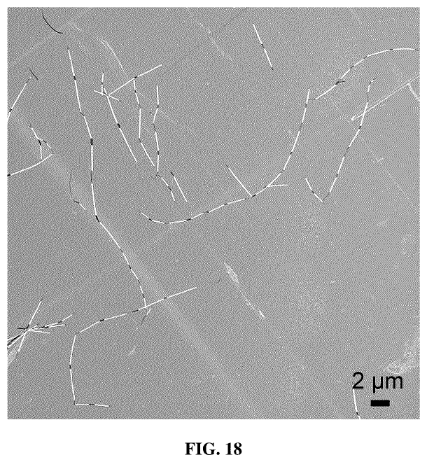

Considering that the relative length of both the rigid and flexible segments on the penta-block heterostructures can be tuned by increasing the feed ratio of polymer component to the component of complex 1, the relative length of both the rigid and flexible segments on the multi-segmented heterostructures can also be regulated by the feed ratio. Meanwhile, due to the long middle flexible segments for the heterostructures formed at high feed ratio, the connection of flexible segments on different penta-block heterostructures during the hierarchical self-assembly can also occur at the middle flexible segments. As a result, branched multi-segmented heterostructures with relatively long flexible segments and short rigid segments were formed (FIG. 19) (Entry no. 7).

### Example 6. Supramolecular Co-Assembly of Various Two-Component Systems Involving Small-Molecule Complexes and PEG-b-PAA (Entry Nos. 8 to 12 in Table 1)

6.1 Supramolecular Co-Assembly of the Two-Component System Involving Complex 1 and PEG₄₅-b-PAA₆₀ (Entry No. 8 in Table 1)

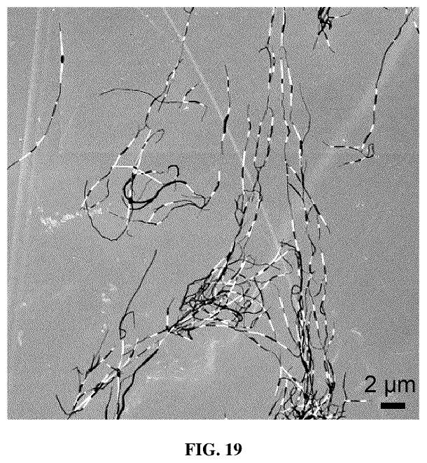

Supramolecular co-assembly of small-molecule complex 1 and PEG₄₅-b-PAA₆₀ was performed by following the same two-step procedure in an aqueous solution. The concentrations of complex 1 and carboxylic acid in the mixture are 0.12 mM and 1.08 mM, respectively. After incubation for 10 minutes, penta-block heterostructures with a coil-rod-coil-rod-coil topology were formed (FIG. 20). The relative length of both the rigid and flexible segments can be controlled by changing the feed ratio.

6.2 Supramolecular Co-Assembly of the Two-Component System Involving Complex 1 and PEG₄₅-b-PAA₁₀₀ (Entry No. 9 in Table 1)

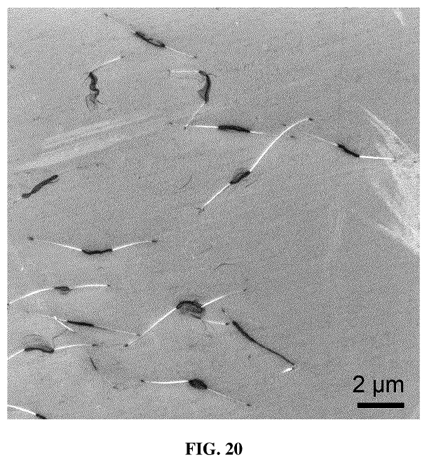

Supramolecular co-assembly of small-molecule complex 1 and PEG₄₅-b-PAA₁₀₀ was performed by following the same two-step procedure in an aqueous solution. The concentrations of complex 1 and carboxylic acid in the mixture are 0.12 mM and 1.08 mM, respectively. After incubation for 10 minutes, penta-block heterostructures with a coil-rod-coil-rod-coil topology were formed (FIG. 21). The relative length of both the rigid and flexible segments can be controlled by changing the feed ratio.

6.3 Supramolecular Co-Assembly of the Two-Component System Involving Complex 1 and PEGn₁₄-b-PAA₆₅ (Entry No. 10 in Table 1)

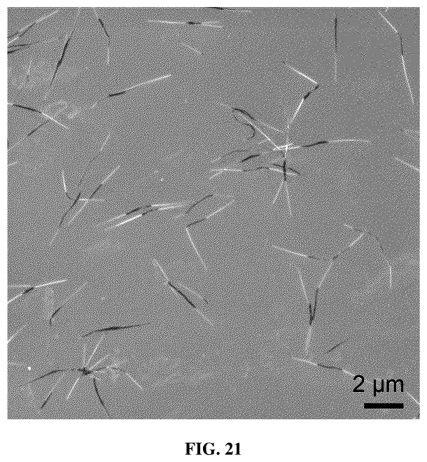

Supramolecular co-assembly of small-molecule complex 1 and PEG₁₁₄-b-PAA₆₅ was performed by following the same two-step procedure in an aqueous solution. The concentrations of complex 1 and carboxylic acid in the mixture are 0.12 mM and 1.08 mM, respectively. After incubation for 10 minutes, penta-block heterostructures with a coil-rod-coil-rod-coil topology were formed (FIG. 22). The relative length of both the rigid and flexible segments can be controlled by changing the feed ratio.

6.4 Supramolecular Co-Assembly of the Two-Component System Involving Complex 2 and PEG₄₅-b-PAA₅₀ (Entry No. 11 in Table 1)

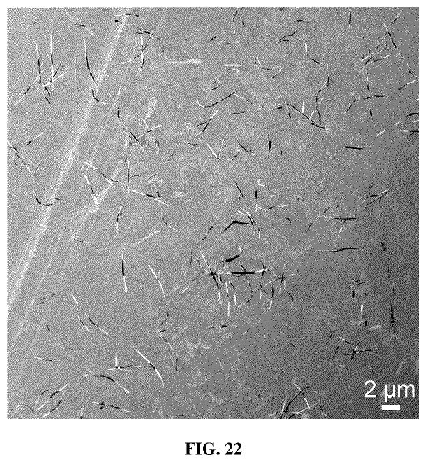

Supramolecular co-assembly of small-molecule complex 2 and PEG₄₅-b-PAA₅₀ was performed by following the same two-step procedure in an aqueous solution. The concentrations of complex 2 and carboxylic acid in the mixture are 0.15 mM and 0.60 mM, respectively. After incubation for one day, penta-block heterostructures with a coil-rod-coil-rod-coil topology were formed (FIG. 23). The relative length of both the rigid and flexible segments can be controlled by changing the feed ratio.

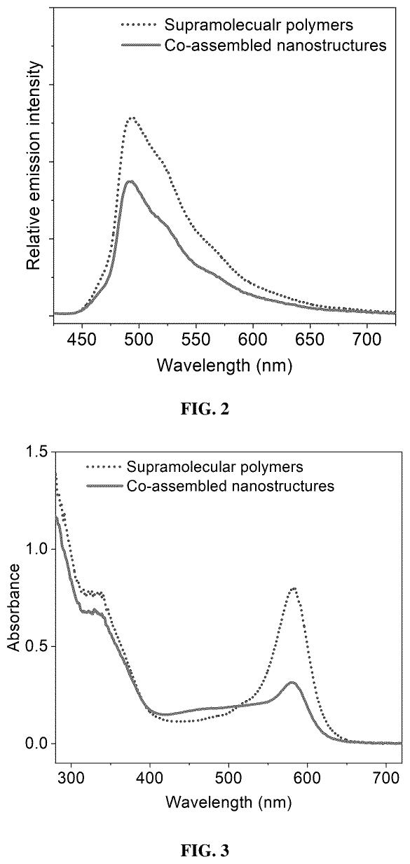

The UV-vis spectrum of supramolecular polymers of complex 2 (precursors) showed an absorbance band at approximately 580 nm (FIG. 3). This absorption band was originated from metal-metal-to-ligand charge transfer (MMLCT) transitions in the formed infinite chains of complex 2 during supramolecular polymerization. After co-assembly with the polymer components, the intensity of the absorbance band at 580 nm decreased, which can be attributed to the breakage of original infinite chains of orderly stacked complex 2 into shorter ones or oligomers of complex 2. The steady-state emission spectra were recorded by excitation at the isosbestic wavelength of 520 nm (FIG. 4). The MMLCT emission bands of the precursors appeared at 730 nm while blue-shifted to 700 nm after co-assembled with PEG₄₅-b-PAA₅₀. Without wishing to be bound by theory, it is believed that the different trend in the emission wavelength and intensity for the supramolecular polymers and the co-assembled nanostructures may be due to the difference in molecular packing and microenvironment of the complexes in the supramolecular polymers and the co-assembled nanostructures.

6.5 Supramolecular Co-Assembly of the Two-Component System Involving Complex 4 and PEG₄₅-b-PAA₅₀ (Entry No. 12 in Table 1)

Supramolecular co-assembly of small-molecule complex 4 and PEG₄₅-b-PAA₅₀ was performed by following the same two-step procedure in an aqueous solution. The concentrations of complex 4 and carboxylic acid in the mixture are 0.15 mM and 0.60 mM, respectively. After incubation for 30 minutes, penta-block heterostructures with a coil-rod-coil-rod-coil topology were formed (FIG. 15). The relative length of both the rigid and flexible segments can be controlled by changing the feed ratio.

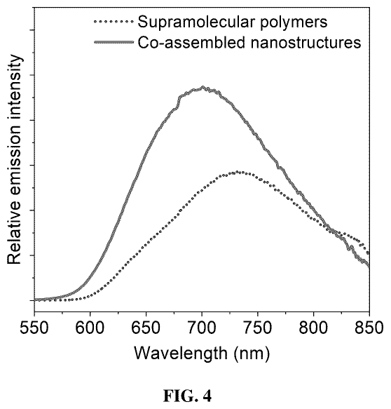

The UV-vis spectrum of supramolecular polymers of complex 4 (precursors) showed an absorbance band at approximately 590 nm (FIG. 5). This absorption band originated from metal-metal-to-ligand charge transfer (MMLCT) transitions in the formed infinite chains of complex 4 during supramolecular polymerization. After co-assembly with the polymer components, the intensity of the absorbance band at 590 nm decreased, which can be attributed to the breakage of original infinite chains of orderly stacked complex 4 into shorter ones or oligomers of complex 4. The steady-state emission spectra were recorded by excitation at the isosbestic wavelength of 430 nm (FIG. 6). The³MMLCT emission bands of the precursors appeared at 680 nm while red-shifted to 760 nm after co-assembled with PEG₄₅-b-PAA₅₀.

### Example 7. Construction of Tri-Block Heterostructures from Supramolecular Co-Assembly of the Two-Component System Involving Complex 3 and PEG₄₅-b-PAA₅₀ (Entry No. 13 in Table 1)

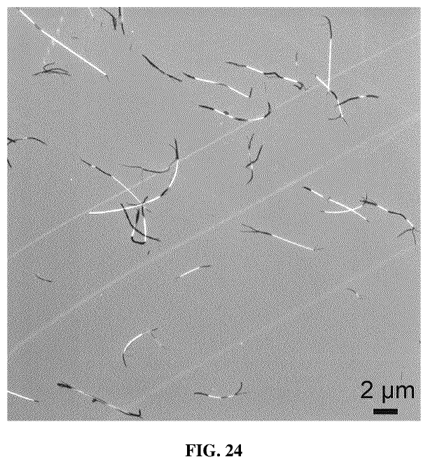

Supramolecular co-assembly of small-molecule complex 3 and PEG₄₅-b-PAA₅₀ was performed by following the same two-step procedure in an aqueous solution. The concentrations of complex 3 and carboxylic acid in the mixture are 0.15 mM and 0.60 mM, respectively. After incubation for 10 minutes, tri-block heterostructures with a coil-rod-coil topology were formed (FIG. 25). The relative length of both the rigid and flexible segments can be controlled by changing the feed ratio.

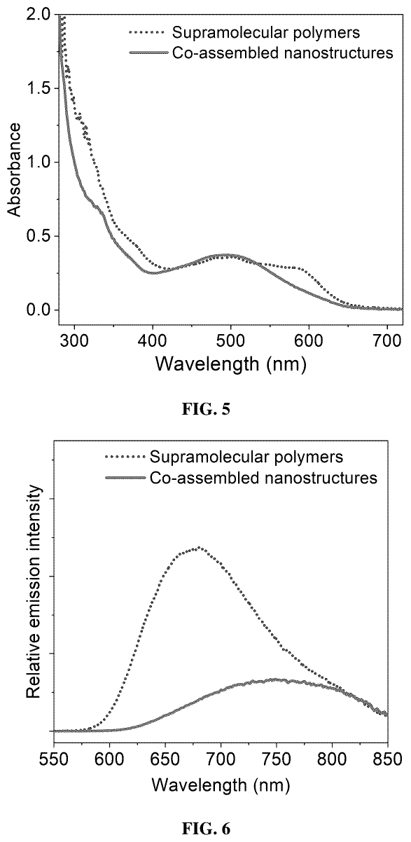

The UV-vis spectrum of supramolecular polymers of complex 3 (precursors) showed an absorbance band at approximately 560 nm (FIG. 7). This absorption band originated from metal-metal-to-ligand charge transfer (MMLCT) transitions in the formed infinite chains of complex 3 during supramolecular polymerization. After co-assembly with the polymer components, the intensity of the absorbance band at 560 nm decreased, which can be attributed to the breakage of original infinite chains of orderly stacked complex 3 into shorter ones or oligomers of complex 3. The steady-state emission spectra were recorded by excitation at the isosbestic wavelength of 522 nm (FIG. 8). The³MMLCT emission bands of the precursors appeared at 640 nm while red-shifted to 700 nm after co-assembled with PEG₄₅-b-PAA₅₀. Without wishing to be bound by theory, it is believed that the different trend in the emission wavelength and intensity for the supramolecular polymers and the co-assembled nanostructures may be due to the difference in molecular packing and microenvironment of the complexes in the supramolecular polymers and the co-assembled nanostructures.

Example 8. Construction of Tri-Block Heterostructures from Supramolecular Co-Assembly of Various Two-Component Systems Involving Small-Molecule Complexes and PEG-b-PAA (Entry Nos. 14 to 16 in Table 1)

8.1 Supramolecular Co-Assembly of Complex 1 and PEG₄₅-b-PAA₄₃ (Entry No. 14 in Table 1)

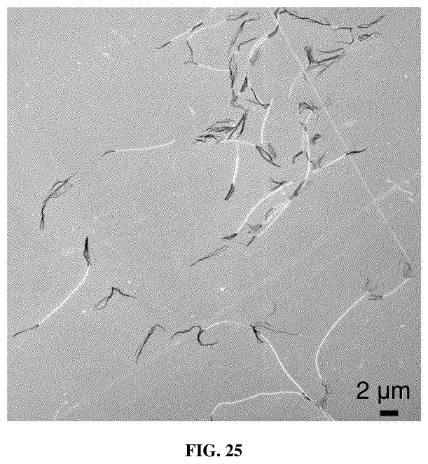

Supramolecular co-assembly of small-molecule complex 1 and PEG₄₅-b-PAA₄₃ was performed by following the two-step procedure in an aqueous solution. In the first step, supramolecular polymers of complex 1 were prepared as precursors by mixing the acetonitrile solution of complex 1 and water and then incubating for at least 6 hours. Afterwards, the supramolecular polymers were treated with sonication to break them into shorter ones. Such kinds of short supramolecular polymers were then used as precursors for the co-assembly in the second step. The concentrations of complex 1 and carboxylic acid in the mixture are 0.15 mM and 0.60 mM, respectively. After incubation for 5 minutes, tri-block heterostructures with a coil-rod-coil topology were formed (FIG. 26). The relative length of both the rigid and flexible segments can be controlled by changing the feed ratio.

8.2 Supramolecular Co-Assembly of Complex 4 and PEG₄₅-b-PAA₅₀ (Entry No. 15 in Table 1)

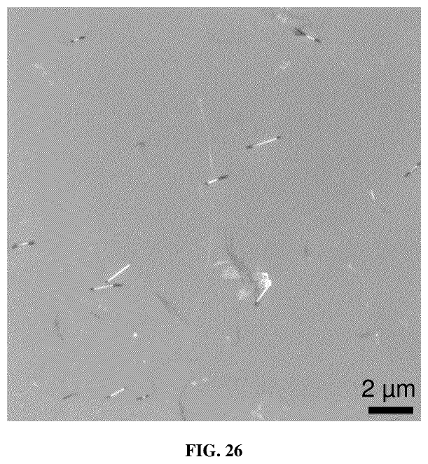

Supramolecular co-assembly of small-molecule complex 4 and PEG₄₅-b-PAA₅₀ was performed by following the two-step procedure in an aqueous solution. In the first step, supramolecular polymers of complex 4 were prepared as precursors by mixing the acetonitrile solution of complex 4 and water and then incubating for at least 6 hours. Afterwards, the supramolecular polymers were treated with sonication to break them into shorter ones. Such kinds of short supramolecular polymers were then used as precursors for the co-assembly in the second step. The concentrations of complex 1 and carboxylic acid in the mixture are 0.15 mM and 0.60 mM, respectively. After incubation for 60 minutes, tri-block heterostructures with a coil-rod-coil topology were formed (FIG. 27). The relative length of both the rigid and flexible segments can be controlled by changing the feed ratio.

8.3 Supramolecular Co-Assembly of Complex 4 and PEG₄₅-b-PAA₅₀ (Entry No. 16 in Table 1)

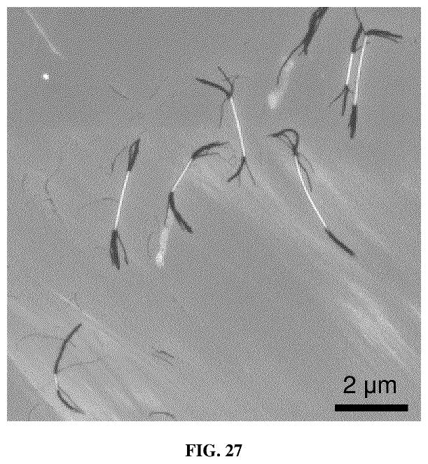

Supramolecular co-assembly of small-molecule complex 4 with counterions of ClO₄⁻ and PEG₄₅-b-PAA₅₀ was performed by following the two-step procedure in an aqueous solution. In the first step, supramolecular polymers of complex 4 was prepared as precursors by mixing the acetonitrile solution of complex 4 and water and then incubating for at least 6 hours. Afterward, the supramolecular polymers were treated with sonication to break them into shorter ones. Such kinds of short supramolecular polymers were then used as precursors for the co-assembly in the second step. The concentrations of complex 1 and carboxylic acid in the mixture are 0.15 mM and 0.60 mM, respectively. After incubation for 5 minutes, tri-block heterostructures with a coil-rod-coil topology were formed (FIG. 28). The relative length of both the rigid and flexible segments can be controlled by changing the feed ratio.

### Example 9. Construction of Penta-Block Heterostructures with a Rod-Coil-Rod Topology from Supramolecular Co-Assembly of Supramolecular Copolymers and PEG-b-PAA (Entry No. 17 in Table 1)

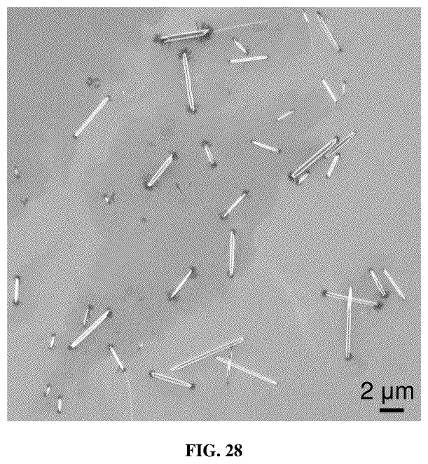

Supramolecular co-assembly of supramolecular copolymers formed from seeded growth of complex 1 and complex 2 and PEG₄₅-b-PAA₅₀ was performed by following the same two-step procedure in an aqueous solution. The concentrations of complex 1, complex 2, and carboxylic acid in the mixture are 0.15 mM, 0.04 mM, and 0.50 mM, respectively. In the first step, supramolecular copolymers were prepared though a seeded grow method by using supramolecular polymers of complex 2 as seeds. Freshly prepared solution of complex 1 was added to the seeds' solution to afford the supramolecular copolymers. Afterwards, the supramolecular copolymers were used as precursors for supramolecular co-assembly with PEG₄₅-b-PAA₅₀ to construct the nanostructures with spatially distinct features. After incubation for one day, penta-block heterostructures with a rod-coil-rod topology were formed when the co-assembly in the second step was selectively occurred at the central region of the supramolecular copolymers (FIG. 29). The relative length of both the rigid and flexible segments can be controlled by changing the feed ratio. Alternatively, the supramolecular copolymers can also be prepared by using supramolecular polymers of complex 1 as seeds to form the central block. As a result, penta-block heterostructures with a reversed sequence can be fabricated.

Example 10. Construction of Hepta-Block Heterostructures with a Coil-Rod-Coil-Rod-Coil Topology from Supramolecular Co-Assembly of Supramolecular Copolymers and PEG-b-PAA (Entry No. 18 and No. 19 in Table 1)

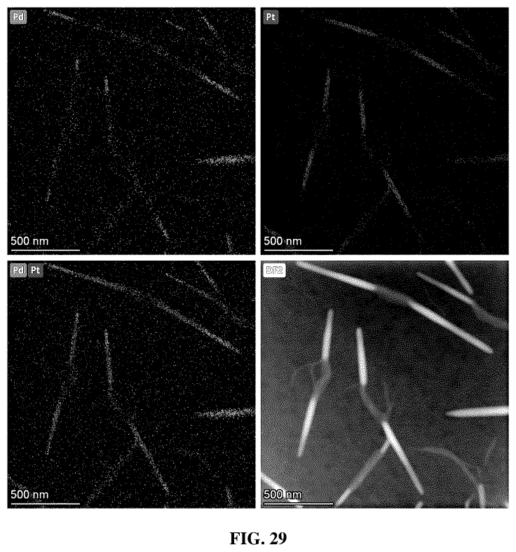

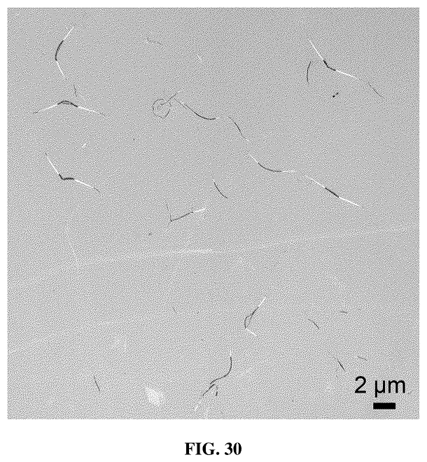

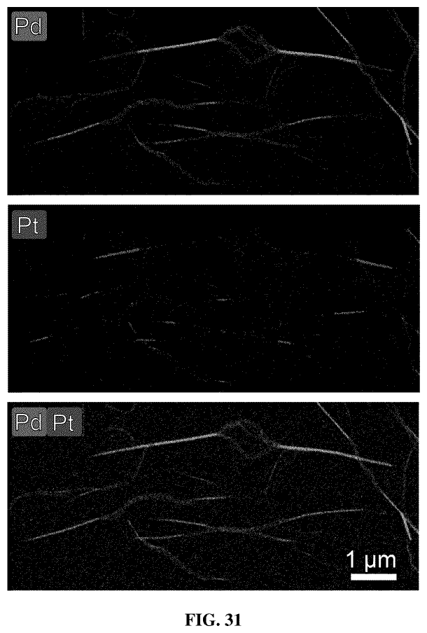

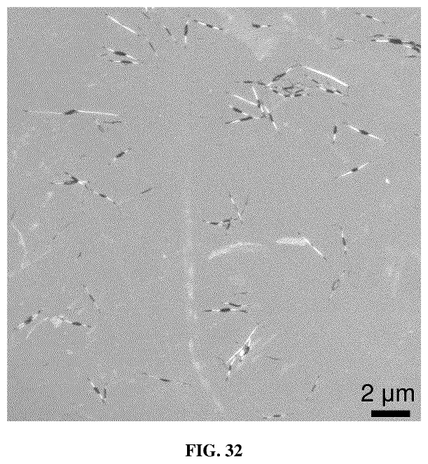

Supramolecular co-assembly of supramolecular copolymers formed from seeded growth of complex 1 and complex 2 and PEG₄₅-b-PAA₅₀ was performed by following the same two-step procedure in an aqueous solution. The concentrations of complex 1, complex 2, and carboxylic acid in the mixture are 0.05 mM, 0.04 mM, and 0.54 mM, respectively. In the first step, supramolecular copolymers were prepared though a seeded grow method by using supramolecular polymers of complex 2 as seeds. Freshly prepared solution of complex 1 was added to the seeds' solution to afford the supramolecular copolymers. Afterwards, the supramolecular copolymers were used as precursors for supramolecular co-assembly with PEG₄₅-b-PAA₅₀ to construct the nanostructures with spatially distinct features. After incubation for one day, hepta-block heterostructures with a coil-rod-coil-rod-coil topology were formed when the co-assembly in the second step was selectively occurred at both the central region and termini of the supramolecular copolymers (FIG. 30 and FIG. 31). The relative length of both the rigid and flexible segments can be controlled by changing the feed ratio. Alternatively, the supramolecular copolymers can also be prepared by using supramolecular polymers of complex 1 as seeds to form the central block. As a result, penta-block heterostructures with a reversed sequence can be fabricated (FIG. 32 and FIG. 33).

### Example 11. Construction of Multi-Segmented Heterostructures from Hierarchical Self-Assembly of Preformed Hepta-Block Heterostructures (Entry No. 20 and 21 in Table 1)

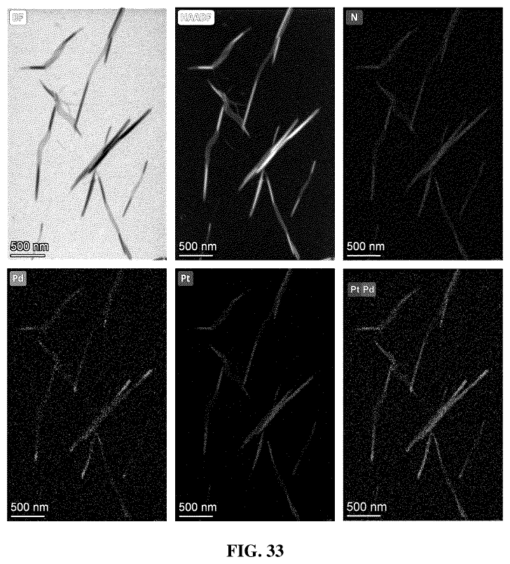

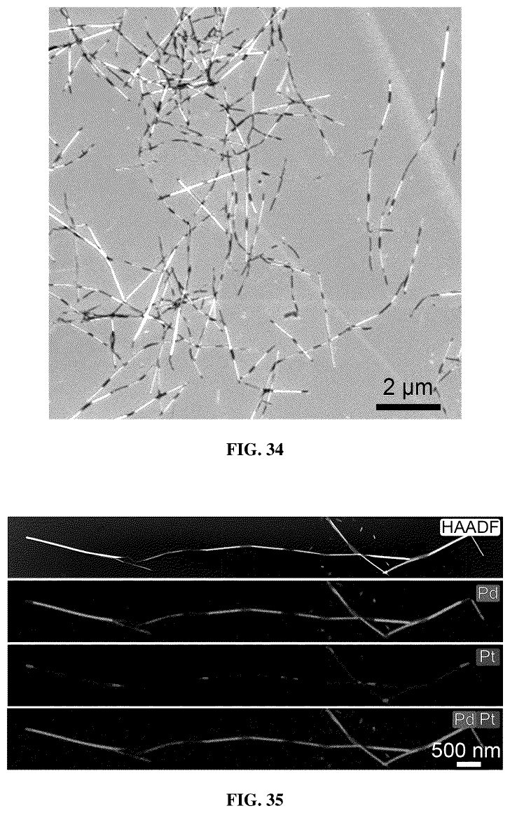

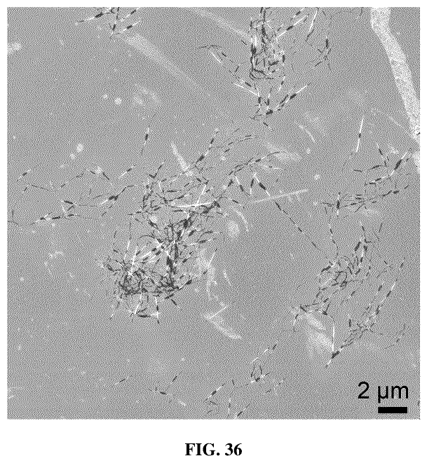

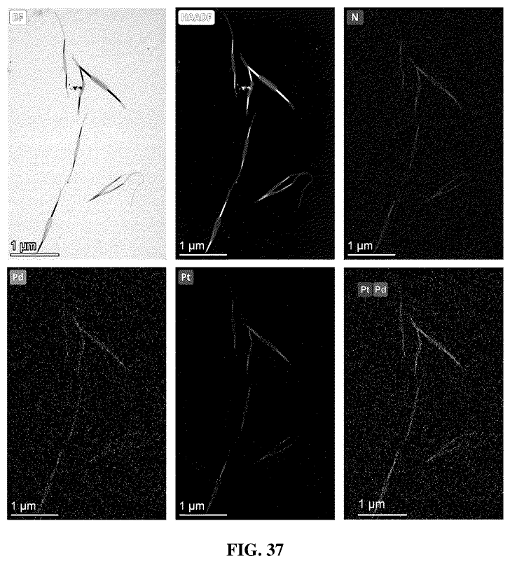

Supramolecular co-assembly of supramolecular copolymers formed from seeded growth of complex 1 and complex 2 and PEG₄₅-b-PAA₅₀ was performed by following the same two-step procedure in an aqueous solution. The concentrations of complex 1, complex 2, and carboxylic acid in the mixture are 0.15 mM, 0.04 mM, and 1.0 mM, respectively. In the first step, supramolecular copolymers were prepared though a seeded grow method by using supramolecular polymers of complex 2 as seeds. Freshly prepared solution of complex 1 was added to the seeds' solution to afford the supramolecular copolymers. Afterwards, the supramolecular copolymers were used as precursors for supramolecular co-assembly with PEG₄₅-b-PAA₅₀ to construct the nanostructures with spatially distinct features. During the incubation, hepta-block heterostructures with a coil-rod-coil-rod-coil topology were formed at the earlier stage. Upon further incubation, the preformed hepta-block heterostructures were found to undergo hierarchical self-assembly. As a result, multi-segmented heterostructures with alternate rigid and flexible segments were formed. Each rigid segment was composed of two blocks (FIG. 34 and FIG. 35). The two blocks are composed of complex 1 and complex 2 individually. The relative length of both the rigid and flexible segments can be controlled by changing the feed ratio. Alternatively, the supramolecular copolymers can also be prepared by using supramolecular polymers of complex 1 as seeds to form the central block. As a result, similar multi-segmented heterostructures containing complex compositions and architectures can be also fabricated (FIG. 36 and FIG. 37).

Additional exemplary agents and concentrations to prepare supramolecular nanostructures are shown in Table 2 below.

TABLE 2
Exemplary agents and concentrations to prepare supramolecular
nanostructures with spatially distinct features

| | Small- | | | Morphology of |
|---|---|---|---|---|
| Entry | molecular | Polymer | | the |
| no. | component | component | Media | nanostructures |
| 1 | Complex 1 | PEG₄₅-b-PAA₅₀ | Aqueous | Tri-block with |
| | (X⁻ = PF₆⁻) | (1.0 mM | Incubation | a loop-rod-loop |
| | (0.30 mM) | carboxylic acid) | for 1 day | topology |
| 2 | Complex 1 | PEG₄₅-b-PAA₅₀ | Aqueous | Penta-block |
| | (X⁻ = PF₆⁻) | (1.0 mM | Incubation | with a loop- |
| | (0.30 mM) | carboxylic acid) | for 1 day | rod-loop-rod- |
| | | | | loop topology |
| 3 | Complex 1 | PEG₄₅-b-PAA₃₅ | Aqueous | Diblock with a |
| | (X⁻ = PF₆⁻) | (1.0 mM | Incubation | rod-coil |
| | (0.30 mM) | carboxylic acid) | for 1 day | topology |
| 4 | Complex 1 | PEG₄₅-b-PAA₅₀ | Aqueous | Diblock with a |
| | (X⁻ = PF₆⁻) | (1.0 mM | Incubation | rod-loop |
| | (0.30 mM) | carboxylic acid) | for 1 day | topology |
| 5 | Complex 2 | PEG₄₅-b-PAA₃₅ | Aqueous | Tri-block with |
| | (X⁻ = PF₆⁻) | (0.75 mM | Incubation | a rod-coil-rod |
| | (0.30 mM) | carboxylic acid) | for 1 day | topology |
| 6 | Complex 2 | PEG₄₅-b-PAA₃₅ | Aqueous | Penta-block |
| | (X⁻ = PF₆⁻) | (0.75 mM | Incubation | with a coil-rod- |
| | (0.15 mM) | carboxylic acid) | for 1 day | coil-rod-coil |
| | | | | topology |
| 7 | Complex 2 | PEG₄₅-b-PAA₃₅ | Aqueous | Multi-block |
| | (X⁻ = PF₆⁻) | (1.5 mM | Incubation | |
| | (0.20 mM) | carboxylic acid) | for 1 day | |
| 8 | Complex 2 | PEG₁₁₄-b-PAA₅₀ | Aqueous | Penta-block |
| | (X⁻ = PF₆⁻) | (0.75 mM | Incubation | with a coil-rod- |
| | (0.15 mM) | carboxylic acid) | for 1 day | coil-rod-coil |
| | | | | topology |
| 9 | Complex 2 | PEG₄₅-b-PAA₅₀ | Aqueous | Penta-block |
| | (X⁻ = ClO₄⁻) | (1.0 mM | Incubation | with a coil-rod- |
| | (0.15 mM) | carboxylic acid) | for 1 day | coil-rod-coil |
| | | | | topology |

Example 12. Construction of Heterostructures with Loop-Shaped Terminal Segments from Supramolecular Co-Assembly of the Two-Component System Involving Complex 1 and PEG₄₅-b-PAA₅₀ (Entry Nos. 1 and 2 in Table 2)

12.1 Construction of Tri-Block Heterostructures from Supramolecular Co-Assembly of Complex 1 and PEG₄₅-b-PAA₅₀ (Entry No. 3 in Table 1)

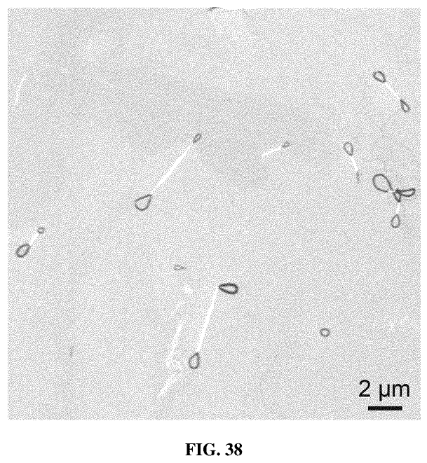

A two-step procedure was adopted for the supramolecular co-assembly of complex 1 and PEG₄₅-b-PAA₅₀ (the subscript represents the degree of polymerization of each block). In the first step, supramolecular polymers of complex 1 were prepared as precursors by mixing the acetonitrile solution of complex 1 and water and then incubating for at least 6 hours. Afterwards, the solution of supramolecular polymers of complex 1 was annealed at 70° C. for 1 hour. In the second step, the preformed aqueous solution of supramolecular polymers was mixed with methanol solution of PEG₄₅-b-PAA₅₀ to perform the co-assembly and tri-block heterostructures with a loop-rod-loop topology were formed (FIG. 38). The concentrations of small-molecule complex 1 and carboxylic acid in the mixture were 0.3 mM and 1.0 mM, respectively.

12.2 Construction of Penta-Block Heterostructures from Supramolecular Co-Assembly of Complex 1 and PEG₄₅-b-PAA₅₀ (Entry No. 2 in Table 2)

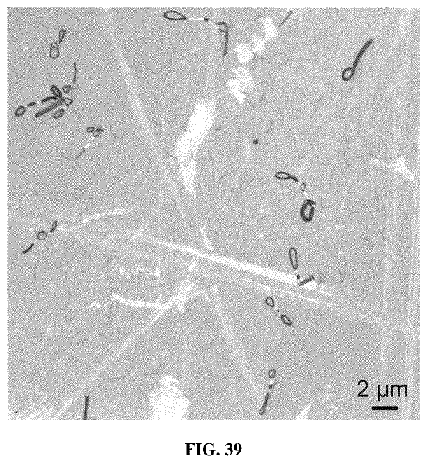

Supramolecular co-assembly of small-molecule complex 1 and PEG₄₅-b-PAA₅₀ was performed by following a two-step procedure in an aqueous solution. In the first step, the supramolecular polymers were prepared as precursors by mixing the acetonitrile solution of complex 1 and water and then incubating for at least 6 hours. The concentration of complex 1 is 0.30 mM. Afterwards, the solution of supramolecular polymers of complex 1 was annealed at 70° C. for 1 hour and further incubated for at least 24 hours at room temperature. In the second step, the aqueous solution of PEG₄₅-b-PAA₅₀ was added to the solution of supramolecular polymers. The concentrations of small-molecule complex 1 and carboxylic acid in the mixture were 0.3 mM and 1.0 mM, respectively. After incubation for 24 hours, penta-block heterostructures with a loop-rod-loop-rod-loop topology were formed (FIG. 39)

### Example 13. Construction of Unsymmetric Heterostructures from Supramolecular Co-Assembly of the Two-Component System Involving Complex 1 and PEG-b-PAA (Entry Nos. 3 and 4 in Table 2)

13.1 Supramolecular Co-Assembly of Complex 1 and PEG₄₅-b-PAA₃₅ (Entry No. 3 in Table 2)

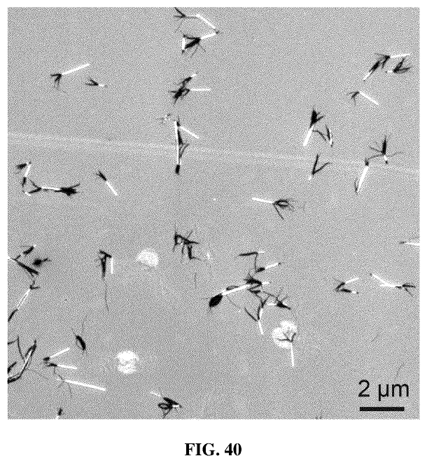

Supramolecular co-assembly of small-molecule complex 1 and PEG₄₅-b-PAA₃₅ was performed by following a two-step procedure in an aqueous solution. In the first step, the supramolecular polymers were prepared as precursors by mixing the acetonitrile solution of complex 1 and water and then incubating for at least 6 hours. The concentration of complex 1 is 0.30 mM. Afterwards, the solution of supramolecular polymers of complex 1 was annealed at 70° C. for 1 hour. Next, the solution of above supramolecular polymers of complex 1 was treated with sonication (100 W, 2 minutes) to break them into short ones with newly grown termini. In the second step, the aqueous solution of PEG₄₅-b-PAA₃₅ was added to the solution of supramolecular polymers. The concentrations of small-molecule complex 1 and carboxylic acid in the mixture were 0.3 mM and 1.0 mM, respectively. The newly grown terminus of each supramolecular polymer exhibits lower activity than the original termini of the supramolecular polymers, therefore, the complexes in the two termini of supramolecular polymers showed different kinetics for electrostatic co-assembly with the added PEG₄₅-b-PAA₃₅. As a result, unsymmetric heterostructures with a rod-coil topology were formed (FIG. 40).

13.2 Supramolecular Co-Assembly of Complex 1 and PEG₄₅-b-PAA₅₀ (Entry No. 4 in Table 2)

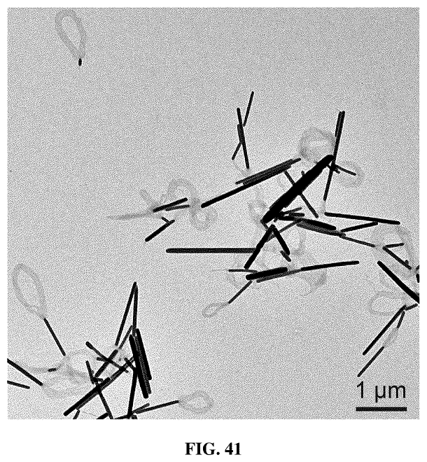

Supramolecular co-assembly of small-molecule complex 1 and PEG₄₅-b-PAA₅₀ was performed by following a two-step procedure in an aqueous solution. In the first step, the supramolecular polymers were prepared as precursors by mixing the acetonitrile solution of complex 1 and water and then incubating for at least 6 hours. The concentration of complex 1 is 0.30 mM. Afterwards, the solution of supramolecular polymers of complex 1 was annealed at 70° C. for 1 hour. Next, the solution of above supramolecular polymers of complex 1 was treated with sonication (100 W, 2 minutes) to break them into short ones with newly grown termini. In the second step, the aqueous solution of PEG₄₅-b-PAA₅₀ was added to the solution of supramolecular polymers. The concentrations of small-molecule complex 1 and carboxylic acid in the mixture were 0.3 mM and 1.0 mM, respectively. The newly grown terminus of each supramolecular polymer exhibits lower activity than the original termini of the supramolecular polymers, therefore, the complexes in the two termini of supramolecular polymers showed different kinetics for electrostatic co-assembly with the added PEG₄₅-b-PAA₅₀. The complexes and PEG₄₅-b-PAA₅₀ preferred to form closed loop which were still connected with the residual part of the supramolecular polymers and thus unsymmetric heterostructures with a rod-loop topology formed (FIG. 41).

### Example 14. Construction of Heterostructures from Supramolecular Co-Assembly of the Two-Component System Involving Complex 2 and PEG-b-PAA (Entry Nos. 5 to 8 in Table 2)

14.1 Tri-Block Heterostructures from Supramolecular Co-Assembly of Complex 2 and PEG₄₅-b-PAA₃₅ (Entry No. 5 in Table 2)

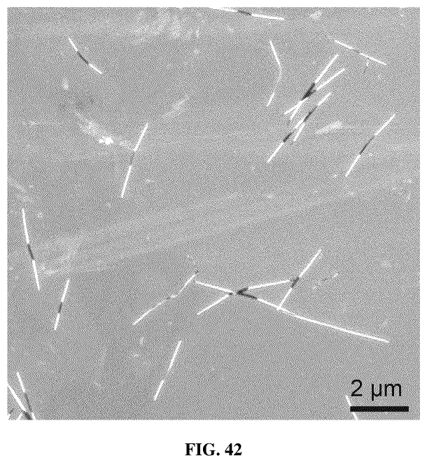

Supramolecular co-assembly of small-molecule complex 2 and PEG₄₅-b-PAA₃₅ was performed by following the two-step procedure in an aqueous solution. In the first step, supramolecular polymers of complex 2 were prepared as precursors by mixing the acetonitrile solution of complex 2 and water and then incubating for at least 6 hours. In the second step, the aqueous solution of PEG₄₅-b-PAA₃₅ was added to the solution of supramolecular polymers. The concentrations of complex 2 and carboxylic acid in the mixture are 0.3 mM and 0.75 mM, respectively. After incubation for 24 hours, tri-block heterostructures with a rod-coil-rod topology were formed (FIG. 42).

14.2 Penta-Block Heterostructures from Supramolecular Co-Assembly of Complex 2 and PEG₄₅-b-PAA₃₅ (Entry No. 6 in Table 2)

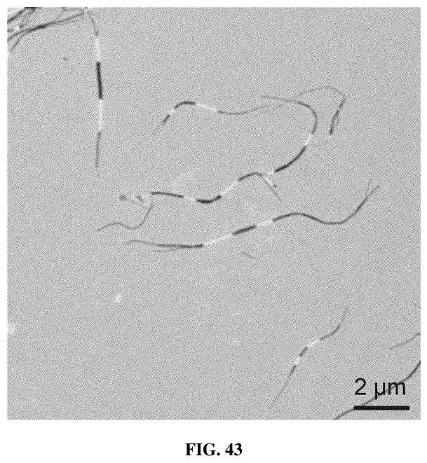

Supramolecular co-assembly of small-molecule complex 2 and PEG₄₅-b-PAA₃₅ was performed by following the two-step procedure in an aqueous solution. In the first step, supramolecular polymers of complex 2 were prepared as precursors by mixing the acetonitrile solution of complex 2 and water and then incubating for at least 6 hours. In the second step, the aqueous solution of PEG₄₅-b-PAA₃₅ was added to the solution of supramolecular polymers. The concentrations of complex 2 and carboxylic acid in the mixture are 0.15 mM and 0.75 mM, respectively. After incubation for 24 hours, penta-block heterostructures with a coil-rod-coil-rod-coil topology were formed (FIG. 43).

14.3 Multi-Block Heterostructures from Supramolecular Co-Assembly of Complex 2 and PEG₄₅-b-PAA₃₅ (Entry No. 7 in Table 2)

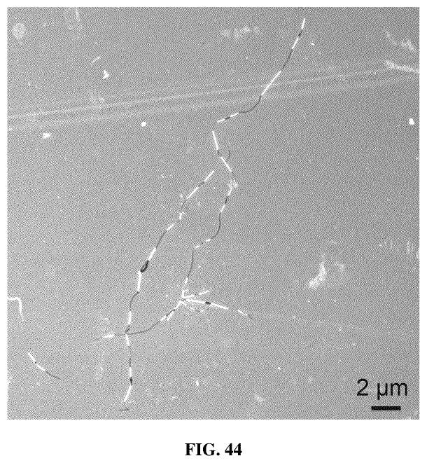

Supramolecular co-assembly of small-molecule complex 2 and PEG₄₅-b-PAA₃₅ was performed by following the two-step procedure in an aqueous solution. In the first step, supramolecular polymers of complex 2 were prepared as precursors by mixing the acetonitrile solution of complex 2 and water and then incubating for at least 6 hours. In the second step, the aqueous solution of PEG₄₅-b-PAA₃₅ was added to the solution of supramolecular polymers. The concentrations of complex 2 and carboxylic acid in the mixture are 0.2 mM and 1.5 mM, respectively. After incubation for 24 hours, multi-block heterostructures with alternate rigid and flexible segments were formed (FIG. 44).

14.4 Tri-Block Heterostructures from Supramolecular Co-Assembly of Complex 2 and PEG₁₄-b-PAA₅₀ (Entry No. 8 in Table 2)

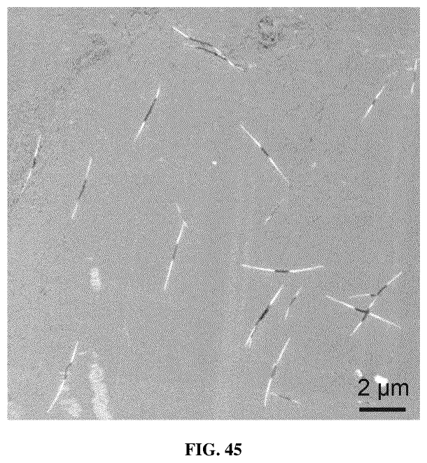

Supramolecular co-assembly of small-molecule complex 2 and PEG₁₁₄-b-PAA₅₀ was performed by following the two-step procedure in an aqueous solution. In the first step, supramolecular polymers of complex 2 were prepared as precursors by mixing the acetonitrile solution of complex 2 and water and then incubating for at least 6 hours. In the second step, the aqueous solution of PEG₁₁₄-b-PAA₅₀ was added to the solution of supramolecular polymers. The concentrations of complex 2 and carboxylic acid in the mixture are 0.15 mM and 0.75 mM, respectively. After incubation for 24 hours, tri-block heterostructures with a rod-coil-rod topology were formed (FIG. 45).

### Example 15. Construction of Coaxial Heterostructures from Supramolecular Co-Assembly of the Two-Component System Involving Complex 2 and PEG₄₅-b-PAA₅₀ (Entry No. 9 in Table 2)

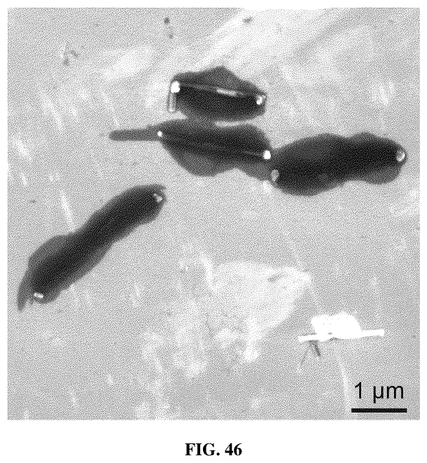

Supramolecular co-assembly of small-molecule complex 2 with a counterion of ClO₄⁻ and PEG₄₅-b-PAA₅₀ was performed by following a two-step procedure in an aqueous solution. In the first step, the supramolecular polymers were prepared as precursors by mixing the acetonitrile solution of complex 2 and water and then incubating for at least 12 hours. Afterwards, the solution of supramolecular polymers was treated with sonication (100 W, 5 minutes). The mixture was kept standing at room temperature for 2 hours before conducting the co-assembly. In the second step, the aqueous solution of PEG₄₅-b-PAA₅₀ was added to the solution of supramolecular polymers. The concentrations of small-molecule complex 2 and carboxylic acid in the mixture were 1.5 mM and 1.0 mM, respectively. After incubation for at least 24 hours, coaxial heterostructures with one rigid rod surrounded by concentric multi-layered flexible shells were formed (FIG. 46).

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

It is understood that the disclosed method and compositions are not limited to the particular methodology, protocols, and reagents described as these may vary. It is also to be understood that the terminology used herein is for the purpose of describing particular embodiments only and is not intended to limit the scope of the present invention which will be limited only by the appended claims.

It must be noted that as used herein and in the appended claims, the singular forms “a”, “an”, and “the” include plural reference unless the context clearly dictates otherwise. Thus, for example, reference to “a small molecule” includes a plurality of such small molecule, reference to “the small molecule” is a reference to one or more small molecules and equivalents thereof known to those skilled in the art, and so forth.

“Optional” or “optionally” means that the subsequently described event, circumstance, or material may or may not occur or be present, and that the description includes instances where the event, circumstance, or material occurs or is present and instances where it does not occur or is not present.

Ranges may be expressed herein as from “about” one particular value, and/or to “about” another particular value. When such a range is expressed, also specifically contemplated and considered disclosed is the range from the one particular value and/or to the other particular value unless the context specifically indicates otherwise. Similarly, when values are expressed as approximations, by use of the antecedent “about”, it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. It should be understood that all of the individual values and sub-ranges of values contained within an explicitly disclosed range are also specifically contemplated and should be considered disclosed unless the context specifically indicates otherwise. Finally, it should be understood that all ranges refer both to the recited range as a range and as a collection of individual numbers from and including the first endpoint to and including the second endpoint. In the latter case, it should be understood that any of the individual numbers can be selected as one form of the quantity, value, or feature to which the range refers. In this way, a range describes a set of numbers or values from and including the first endpoint to and including the second endpoint from which a single member of the set (i.e. a single number) can be selected as the quantity, value, or feature to which the range refers. The foregoing applies regardless of whether in particular cases some or all of these embodiments are explicitly disclosed.

Unless defined otherwise, all technical and scientific terms used herein have the same meanings as commonly understood by one of skill in the art to which the disclosed method and compositions belong. Although any methods and materials similar or equivalent to those described herein can be used in the practice or testing of the present method and compositions, the particularly useful methods, devices, and materials are as described. Publications cited herein and the material for which they are cited are hereby specifically incorporated by reference. Nothing herein is to be construed as an admission that the present invention is not entitled to antedate such disclosure by virtue of prior invention. No admission is made that any reference constitutes prior art. The discussion of references states what their authors assert, and applicants reserve the right to challenge the accuracy and pertinence of the cited documents. It will be clearly understood that, although a number of publications are referred to herein, such reference does not constitute an admission that any of these documents' forms part of the common general knowledge in the art.

Those skilled in the art will recognize or be able to ascertain using no more than routine experimentation, many equivalents to the specific embodiments of the method and compositions described herein. Such equivalents are intended to be encompassed by the following claims.

We claim:

1. A supramolecular nanostructure having spatially distinct features, comprising a plurality of one or more small-molecule components, wherein the small-molecule components have a planar or linear geometry, wherein the small molecule components are solvophobic in a first solvent, and wherein the small-molecule components are associated with one another based on non-covalent interactions, preferably comprising metal-metal interactions, π-π interactions, hydrogen-bonding interactions, solvophobic-solvophobic interactions, or a combination thereof, and
a polymer component, wherein the polymer component is solvophilic in the first solvent, and wherein the polymer component is in a non-covalent interaction with some or all of the small-molecule components,
wherein the supramolecular nanostructure contains at least one rigid segment and at least one flexible segment preferably in an alternating configuration; wherein:
(a) the nanostructure of the at least one rigid segment preferably comprises a nanorod;
(b) the nanostructure of the at least one flexible segment preferably comprises nanofibers, nano-belts, nano-ribbons, or nano-loops; and preferably wherein the supramolecular nanostructure has active ends.

2. The supramolecular nanostructure of claim 1, wherein the at least one flexible segment on the supramolecular nanostructure comprises a core-shell structure,
wherein the shell comprises at least a portion of the polymer component, and the core comprises the small-molecule components.

3. The supramolecular nanostructure of claim 1, wherein the at least one rigid segment and the at least one flexible segment containing small-molecule components comprise metal complexes of a square-planar configuration with monodentate, bidentate, tridentate, or tetradentate coordinating ligands, wherein the metal complex is defined by the following formula, 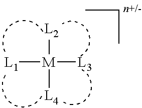
wherein:
(a) M is Ni(II), Pd(II), Pt(II), Rh(I), Ir(I), Au(III), Cu(III), Zn(II) or Cu(II);
(b) L₁, L₂, L₃, and L₄ represent the coordinating ligands with donor atoms independently selected from N, C, O, S, Se, P and As;
(c) the dashed lines indicate that the covalent linkages between neighboring ligands may exist or may not exist;
(d) n+/− represents the number of positive charges or negative charges carried by the metal complexes, and n is selected from 0, 1, 2, 3, 4, 5 and 6.

4. The supramolecular nanostructure of claim 1, wherein the small-molecule components comprise metal complexes of a trigonal-planar configuration with monodentate, bidentate, or tridentate coordinating ligands, wherein the metal complex is defined by the following formula, 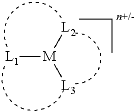
wherein:
(a) M is Cu(I), Ag(I), Au(I), Ni(0), Pd(0), Pt(0), Zn(II), Cd(II) or Hg(II);
(b) L₁, L₂, and L₃ represent the coordinating ligands with donor atoms independently selected from N, C, O, S, Se, P and As;
(c) the dashed lines indicate that the covalent linkages between neighboring ligands may exist or may not exist;
(d) n+/− represents the number of positive charges or negative charges carried by the metal complexes, and n is selected from 0, 1, 2, 3, 4, 5 and 6.

5. The supramolecular nanostructure of claim 1, wherein the small-molecule components comprise metal complexes of a linear configuration, wherein the metal complex is defined by the following formula, 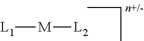
wherein:
(a) M is Cu(I), Ag(I), Au(I), Ni(0), Pd(0), Pt(0), Zn(II), Cd(II) or Hg(II);
(b) L₁ and L₂ represent the coordinating ligands with donor atoms independently selected from N, C, O, S, Se, P and as;
(c) n+/− represents the number of positive charges or negative charges carried by the metal complexes, and n is selected from 0, 1, 2, 3, 4, 5 and 6.

6. The supramolecular nanostructure of claim 1, wherein the small-molecule components comprise planar organic molecules that are positively charged, negatively charged, or charge-neutral.

7. The supramolecular nanostructure of claim 1, wherein the small-molecule components comprise a palladium(II) 6-phenyl-2,2′-bipyridine complex defined by the following formula, 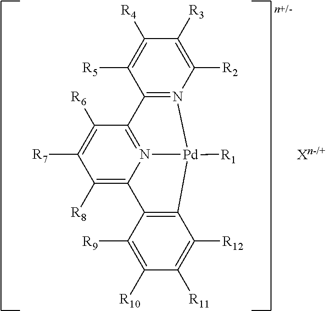
wherein:
R₁ is selected from, but not limited to, C≡N—R′, pyridine, phosphine, N-heterocyclic carbenes, where R′ is H or substituted or unsubstituted C₁-C₃₀ alkyl, C₂-C₃₀ alkenyl, C₂-C₃₀ alkynyl, C₃-C₃₀ aryl (e.g., phenyl, tolyl, xylyl, and naphthyl), C₃-C₃₀ heteroaryl, C₁-C₃₀ alkoxy, C₃-C₃₀ phenoxy, C₃-C₃₀ aryloxy, C₃-C₃₀ arylthio, C₁-C₃₀ alkylthio, C₂-C₃₀ carbonyl, C₁-C₃₀ carboxyl, amino, amido, polyaryl, optionally substituted by one or more heteroatoms;
R₂, R₃, R₄, R₅, R₆, R₇, R₈, R₉, R₁₀, R₁₁ and R₁₂ are, independently, H, C₁-C₃₀ alkyl, C₂-C₃₀ alkenyl, C₂-C₃₀ alkynyl, C₃-C₃₀ aryl or N-substituted amide, e.g., the substitution being C₁-C₃₀ alkyl, optionally substituted by one or more heteroatoms;
n+/− represents the number of positive charges or negative charges carried by the metal complexes, and n is selected from 0, 1, 2, 3, 4, 5 and 6; Xⁿ⁻ is an anion, such as, but not limited to, chloride (Cl⁻), nitrate (NO₃⁻), trifluoromethanesulfonate (OTf⁻), hexafluorophosphate (PF₆⁻), perchlorate (ClO₄⁻), tetrafluoroborate (BF₄⁻), and tetraphenylboronate (BPh₄⁻);
Xⁿ⁺ is a cation, such as, but not limited to, Na⁺, K⁺, Ca²⁺, Mg²⁺, bis(triphenylphosphine)iminium (PPN⁺), quaternary ammonium cations, pyridinium cations and phosphonium cations.

8. The supramolecular nanostructure of claim 1, wherein the small-molecule components comprise a platinum(II) 6-phenyl-2,2′-bipyridine complex defined by the following formula, 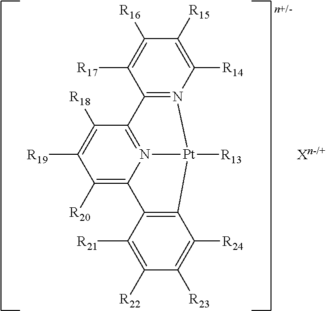
wherein:
R₁₃ is selected from, but not limited to, C≡N—R′, pyridine, phosphine, N-heterocyclic carbenes, where R′ is H or substituted or unsubstituted C₁-C₃₀ alkyl, C₂-C₃₀ alkenyl, C₂-C₃₀ alkynyl, C₃-C₃₀ aryl (e.g., phenyl, tolyl, xylyl, and naphthyl), C₃-C₃₀ heteroaryl, C₁-C₃₀ alkoxy, C₃-C₃₀ phenoxy, C₃-C₃₀ aryloxy, C₃-C₃₀ arylthio, C₁-C₃₀ alkylthio, C₂-C₃₀ carbonyl, C₁-C₃₀ carboxyl, amino, amido, polyaryl, optionally substituted by one or more heteroatoms;
R₁₄, R₁₅, R₁₆, R₁₇, R₁₈, R₁₉, R₂₀, R₂₁, R₂₂, R₂₃ and R₂₄ are, independently, H, C₁-C₃₀ alkyl, C₂-C₃₀ alkenyl, C₂-C₃₀ alkynyl, C₃-C₃₀ aryl or N-substituted amide, e.g., the substitution being C₁-C₃₀ alkyl, optionally substituted by one or more heteroatoms;
n+/− represents the number of positive charges or negative charges carried by the metal complexes, and n is selected from 0, 1, 2, 3, 4, 5 and 6;
Xⁿ⁻ is an anion, such as, but not limited to, chloride (Cl⁻), nitrate (NO₃⁻), trifluoromethanesulfonate (OTf⁻), hexafluorophosphate (PF₆⁻), perchlorate (ClO₄⁻), tetrafluoroborate (BF₄⁻), and tetraphenylboronate (BPh₄⁻);
Xⁿ⁺ is a cation, such as, but not limited to, Na⁺, K⁺, Ca²⁺, Mg²⁺, bis(triphenylphosphine)iminium (PPN⁺), quaternary ammonium cations, pyridinium cations and phosphonium cations.

9. The supramolecular nanostructure of claim 1, wherein the small-molecule components comprise a platinum(II) 1,3-bis(2′-pyridyl)benzene complex defined by the following formula, 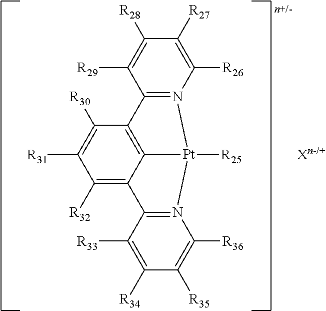
wherein:
R₂₅ is selected from, but not limited to, C≡N—R′, pyridine, phosphine, N-heterocyclic carbenes, where R′ is H or substituted or unsubstituted C₁-C₃₀ alkyl, C₂-C₃₀ alkenyl, C₂-C₃₀ alkynyl, C₃-C₃₀ aryl (e.g., phenyl, tolyl, xylyl, and naphthyl), C₃-C₃₀ heteroaryl, C₁-C₃₀ alkoxy, C₃-C₃₀ phenoxy, C₃-C₃₀ aryloxy, C₃-C₃₀ arylthio, C₁-C₃₀ alkylthio, C₂-C₃₀ carbonyl, C₁-C₃₀ carboxyl, amino, amido, polyaryl, optionally substituted by one or more heteroatoms;
R₂₆, R₂₇, R₂₈, R₂₉, R₃₀, R₃₁, R₃₂, R₃₃, R₃₄, R₃₅ and R₃₆ are, independently, H, C₁-C₃₀ alkyl, C₂-C₃₀ alkenyl, C₂-C₃₀ alkynyl, C₃-C₃₀ aryl or N-substituted amide, e.g., the substitution being C₁-C₃₀ alkyl, optionally substituted by one or more heteroatoms;
n+/− represents the number of positive charges or negative charges carried by the metal complexes, and n is selected from 0, 1, 2, 3, 4, 5 and 6; Xⁿ⁻ is an anion, such as, but not limited to, chloride (Cl⁻), nitrate (NO₃⁻), trifluoromethanesulfonate (OTf⁻), hexafluorophosphate (PF₆⁻), perchlorate (ClO₄⁻), tetrafluoroborate (BF₄⁻), and tetraphenylboronate (BPh₄⁻);
Xⁿ⁺ is a cation, such as, but not limited to, Na⁺, K⁺, Ca²⁺, Mg²⁺, bis(triphenylphosphine)iminium (PPN⁺), quaternary ammonium cations, pyridinium cations and phosphonium cations.

10. The supramolecular nanostructure of claim 1, wherein the small-molecule components comprise an alkynylplatinum(II) terpyridine complex defined by the following formula, 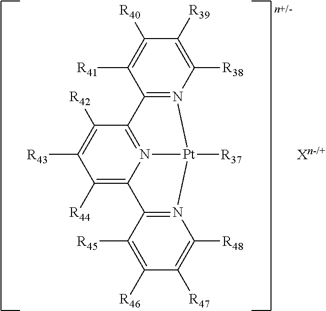
wherein:
R₃₇ is selected from, but not limited to, C≡C—R′, C≡N—R′, pyridine, phosphine, N-heterocyclic carbenes, where R′ is H or substituted or unsubstituted C₁-C₃₀ alkyl, C₂-C₃₀ alkenyl, C₂-C₃₀ alkynyl, C₃-C₃₀ aryl (e.g., phenyl, tolyl, xylyl, and naphthyl), C₃-C₃₀ heteroaryl, C₁-C₃₀ alkoxy, C₃-C₃₀ phenoxy, C₃-C₃₀ aryloxy, C₃-C₃₀ arylthio, C₁-C₃₀ alkylthio, C₂-C₃₀ carbonyl, C₁-C₃₀ carboxyl, amino, amido, polyaryl, optionally substituted by one or more heteroatoms; m is an integer between 1 and 20, e.g., m=1, 2, 3, 4, 5;
R₃₈, R₃₉, R₄₀, R₄₁, R₄₂, R₄₃, R₄₄, R₄₅, R₄₆, R₄₇ and R₄₈ are, independently, H, C₁-C₃₀ alkyl, C₂-C₃₀ alkenyl, C₂-C₃₀ alkynyl, C₃-C₃₀ aryl or N-substituted amide, e.g., the substitution being C₁-C₃₀ alkyl, optionally substituted by one or more heteroatoms;
n+/− represents the number of positive charges or negative charges carried by the metal complexes, and n is selected from 0, 1, 2, 3, 4, 5 and 6; Xⁿ⁻ is an anion, such as, but not limited to, chloride (Cl⁻), nitrate (NO₃⁻), trifluoromethanesulfonate (OTf⁻), hexafluorophosphate (PF₆⁻), perchlorate (ClO₄⁻), tetrafluoroborate (BF₄⁻), and tetraphenylboronate (BPh₄⁻);
Xⁿ⁺ is a cation, such as, but not limited to, Na⁺, K⁺, Ca²⁺, Mg²⁺, bis(triphenylphosphine)iminium (PPN⁺), quaternary ammonium cations, pyridinium cations and phosphonium cations.

11. The supramolecular nanostructure of claim 1, wherein the small-molecule components are selected from the group consisting of 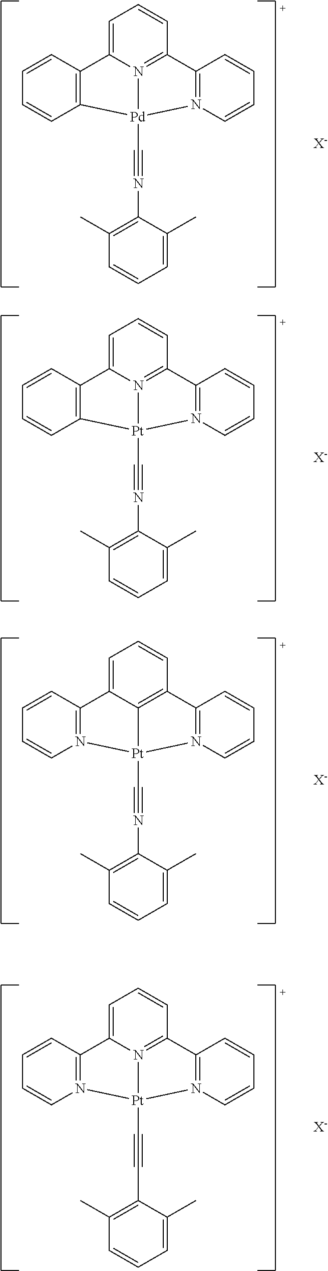
wherein X⁻ is an anion comprising of hexafluorophosphate (PF₆⁻) or perchlorate (ClO₄⁻).

12. The supramolecular nanostructure of claim 1, wherein the polymer component comprises block copolymers, wherein at least one block is a polymer selected from a group consisting of poly(acrylic acid), poly(acrylate), poly(methacrylic acid), poly(methacrylate), poly(acrylamide), poly(methacrylamide), poly(oxide), polyphosphite, polyphosphonate, polyphosphate, polyphosphoramidate, poly(carbonate), poly(ester), poly(anhydride), poly(urethane), poly(diene), poly(acetylene), poly(alkene), poly(vinyl ether), poly(vinyl alcohol), poly(vinyl ketone), poly(vinyl halide), poly(vinyl nitrite), poly(vinyl ester), poly(styrene), poly(vinyl pyridine), quaternized poly(vinyl pyridine), polyethylenimine, poly(lysine), polyphosphonium, polysulfonium, poly(amide), poly(amino acid), polyammonium, poly(lactic acid), poly(saccharide), DNA, RNA, poly(aromatic sulfonate), quaternized poly(arylamine), polyvinylpyrrolidone, poly(ethylene glycol), poly(alkylaminoacrylate), and derivatives thereof, and copolymers thereof.

13. The supramolecular nanostructure of claim 1, wherein the polymer component is a poly(ethylene glycol)-b-poly(acrylic acid).

14. The supramolecular nanostructure of claim 1, wherein the polymer component comprises an amphiphilic polymeric surfactant comprising poly(acrylic acid), poly(acrylate), poly(methacrylic acid), poly(methacrylate), poly(acrylamide), poly(methacrylamide), poly(oxide), polyphosphite, polyphosphonate, polyphosphate, polyphosphoramidate, poly(carbonate), poly(ester), poly(anhydride), poly(urethane), poly(diene), poly(acetylene), poly(alkene), poly(vinyl ether), poly(vinyl alcohol), poly(vinyl ketone), poly(vinyl halide), poly(vinyl nitrite), poly(vinyl ester), poly(styrene), poly(vinyl pyridine), quaternized poly(vinyl pyridine), polyethylenimine, poly(lysine), polyphosphonium, polysulfonium, poly(amide), poly(amino acid), polyammonium, poly(lactic acid), poly(saccharide), DNA, RNA, poly(aromatic sulfonate), quaternized poly(arylamine), polyvinylpyrrolidone, poly(ethylene glycol), poly(alkylaminoacrylate), copolymers thereof, solvophilically or solvophobically, preferably solvophilically, modified derivatives thereof, or hydrophobically or hydrophilically, preferably hydrophilically, modified derivatives thereof.

15. The supramolecular nanostructure of claim 1, wherein the small-molecule components and the polymer component have a range of molar ratio between about 0.005:1 and about 50:1.

16. A method of making supramolecular nanostructures, the method comprising incubating, in a solvent, small-molecule components and a polymer component for a period of time effective to induce formation of the supramolecular nanostructures preferably comprising at least one rigid segment and at least one flexible segment,
wherein the small-molecule components have a planar or linear geometry, wherein the small molecule components are solvophobic with respect to solvent, and wherein the small-molecule components associate with one another based on non-covalent interactions, preferably comprising metal-metal interactions, π-π interactions, hydrogen-bonding interactions, solvophobic-solvophobic interactions, or a combination thereof,
wherein the polymer component is solvophilic with respect to the solvent, and wherein the polymer component interacts with some or all of the small-molecule components non-covalently to stabilize formed supramolecular polymers comprising the small molecule components.

17. The method of claim 16, wherein the at least one flexible segment has one or more nanostructures, preferably wherein the nanostructures comprise nanofibers, nanorods, nano-belts, nano-ribbons, or nano-loops.

18. The method of claim 16, wherein the at least one flexible segment on formed supramolecular nanostructures comprises a core-shell structure, wherein the shell comprises at least a portion of the polymer component and the core comprises the small-molecule components.

19. The method of claim 16, wherein the small-molecule components comprise metal complexes of a square-planar configuration with monodentate, bidentate, tridentate, or tetradentate coordinating ligands, defined by the following formula, 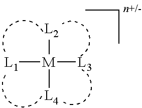
wherein:
(a) M is Ni(II), Pd(II), Pt(II), Rh(I), Ir(I), Au(III), Cu(III), Zn(II) or Cu(II);
(b) L₁, L₂, L₃ and L₄ represents the one or more coordinating ligands with donor atoms independently selected from N, C, O, S, Se, P and As;
(c) the dashed lines indicate that the covalent linkages between neighboring ligands may exist or may not exist;
(d) n+/− represents the number of positive charges or negative charges carried by the metal complexes, and n is selected from 0, 1, 2, 3, 4, 5 and 6.

20. The method of claim 16, wherein the small-molecule components comprise metal complexes of a trigonal-planar configuration with monodentate, bidentate, or tridentate coordinating ligands, defined by the following formula, 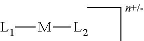
wherein:
(a) M is Cu(I), Ag(I), Au(I), Ni(0), Pd(0), Pt(0), Zn(II), Cd(II) or Hg(II);
(b) Li and L₂ represent the coordinating ligands with donor atoms independently selected from N, C, O, S, Se, P and as;
(c) n+/− represents the number of positive charges or negative charges carried by the metal complexes, and n is selected from 0, 1, 2, 3, 4, 5 and 6.

21. The method of claim 16, wherein the small-molecule components comprise metal complexes of a trigonal-planar configuration with monodentate, bidentate, or tridentate coordinating ligands, wherein the metal complex is defined by the following formula, 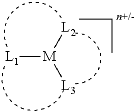
wherein:
(a) M is M is Cu(I), Ag(I), Au(I), Ni(0), Pd(0), Pt(0), Zn(II), Cd(II) or Hg(II);
(b) L₁, L₂, and L₃ represent the coordinating ligands with donor atoms independently selected from N, C, O, S, Se, P and As;
(c) the dashed lines indicate that the covalent linkages between neighboring ligands may exist or may not exist;
(d) n+/− represents the number of positive charges or negative charges carried by the metal complexes, and n is selected from 0, 1, 2, 3, 4, 5 and 6.

22. The method of claim 16, wherein the small-molecule components comprise planar organic molecules that are positively charged, negatively charged, or charge-neutral.

23. The method of claim 16, wherein the polymer component comprises block copolymers wherein at least one block is solvophilic with respect to the solvent and at least one block can bind to the small-molecule components through non-covalent interactions preferably selected from the group consisting of electrostatic attractions, hydrogen-bonding interactions, solvophobic-solvophobic interactions, and π-π interactions.

24. The method of claim 16, wherein the polymer comprises block copolymers wherein at least one block is a polymer selected from the group consisting of poly(acrylic acid), poly(acrylate), poly(methacrylic acid), poly(methacrylate), poly(acrylamide), poly(methacrylamide), poly(oxide), polyphosphite, polyphosphonate, polyphosphate, polyphosphoramidate, poly(carbonate), poly(ester), poly(anhydride), poly(urethane), poly(diene), poly(acetylene), poly(alkene), poly(vinyl ether), poly(vinyl alcohol), poly(vinyl ketone), poly(vinyl halide), poly(vinyl nitrite), poly(vinyl ester), poly(styrene), poly(vinyl pyridine), quaternized poly(vinyl pyridine), polyethylenimine, poly(lysine), polyphosphonium, polysulfonium, poly(amide), poly(amino acid), polyammonium, poly(lactic acid), poly(saccharide), DNA, RNA, poly(aromatic sulfonate), quaternized poly(arylamine), polyvinylpyrrolidone, poly(ethylene glycol), poly(alkylaminoacrylate), and derivatives thereof, and copolymers thereof.

25. The method of claim 16, wherein the polymer component comprises polymeric blocks, preferably, but not limited to, being solvophilic comprising poly(acrylic acid), poly(acrylate), poly(methacrylic acid), poly(methacrylate), poly(acrylamide), poly(methacrylamide), poly(oxide), polyphosphite, polyphosphonate, polyphosphate, polyphosphoramidate, poly(carbonate), poly(ester), poly(anhydride), poly(urethane), poly(diene), poly(acetylene), poly(alkene), poly(vinyl ether), poly(vinyl alcohol), poly(vinyl ketone), poly(vinyl halide), poly(vinyl nitrite), poly(vinyl ester), poly(styrene), poly(vinyl pyridine), quaternized poly(vinyl pyridine), polyethylenimine, poly(lysine), polyphosphonium, polysulfonium, poly(amide), poly(amino acid), polyammonium, poly(lactic acid), poly(saccharide), DNA, RNA, poly(aromatic sulfonate), quaternized poly(arylamine), polyvinylpyrrolidone, poly(ethylene glycol), poly(alkylaminoacrylate), copolymers thereof, solvophobically modified derivatives thereof, or hydrophobically modified derivatives thereof.

26. The method of claim 16, wherein the small-molecule components and the polymer component in the solvent have a range of molar ratio between about 0.005:1 and about 50:1.

27. The method of claim 16, further comprising performing selective spatial co-assembly of the formed supramolecular nanostructure by incubating additional small-molecule components with the formed supramolecular nanostructures,
wherein the additional small-molecule components have a planar or linear geometry and associate non-covalently with one another, with the small-molecule components of the formed supramolecular polymer, or both, and
wherein the polymer component of the at least one flexible segment on the formed supramolecular nanostructure interacts with the additional small-molecule components.

28. The method of claim 27, wherein the additional small-molecule components are identical to the small-molecule components of the formed supramolecular nanostructures.

29. The method of claim 27, wherein the additional small-molecule components are different from the small-molecule components of the formed supramolecular nanostructures.

30. The method of claim 16, wherein the solvent comprises water.

31. The method of claim 16 further comprising fabricating aligned metal nanoparticles or nanomaterials using the formed supramolecular nanostructure as precursors.
